(19) United States
(12) Patent Application Publication
(10) Pub. No.: US 2026/0339722 A1
(43) Pub. Date: Oct. 29, 2026

(54) OVER-SUBSCRIPTION RATIO-BASED SHARDING IN AN AI SYSTEM

(71) Applicant: Microsoft Technology Licensing, LLC, Redmond, WA (US)

(72) Inventors: Nitin BHARDWAJ, Redmond, WA (US); Ashwin Anil GUMASTE, Mountain View, CA (US)

(21) Appl. No.: 19/190,456

(22) Filed: Apr. 25, 2025

(51) Int. Cl. G06F 9/50

(52) U.S. Cl. CPC G06F 9/5027

(57) ABSTRACT

Techniques are described herein that are capable of performing over-subscription ratio-based sharding in an AI system. The AI system includes a first rack of first AI accelerators, NICs associated with the first AI accelerators, and a second rack of second AI accelerators. Subsets of the first AI accelerators establish a consensus regarding allocation of a workload among the first AI accelerators by communicating via the NICs. The consensus indicates portions of data that are to be transmitted from the first rack to the second rack via a Tier1 switch and time durations to be consumed by transmission of the portions. The first AI accelerators group the portions into shards corresponding to respective timeslots based at least on the time durations and an over-subscription ratio associated with the first AI accelerators. Designated first AI accelerators transmit the shards in the respective timeslots to the second rack via the Tier1 switch.

### BACKGROUND

An artificial intelligence (AI) system typically includes AI accelerator racks that are connected through Tier0 and Tier1 Ethernet switches. An AI accelerator rack includes multiple AI accelerator trays that are connected to a common Tier0 Ethernet switch. More specifically, each Tier0 Ethernet switch associated with the AI system is connected to one or more of the AI accelerator racks and routes traffic of those rack(s) to a common Tier1 Ethernet switch for transmission to other AI accelerator rack(s). For example, traffic of a first AI accelerator rack is sent to a second AI accelerator rack through a path that includes (in order) a first Tier0 Ethernet switch associated with the first AI accelerator rack, a Tier1 Ethernet switch, and a second Tier0 Ethernet switch associated with the second AI accelerator rack. Each AI accelerator tray typically includes a processor system (e.g., a central processing unit (CPU)) and multiple AI accelerators.

However, Tier0 Ethernet switches typically are configured to have an over-subscription ratio. An over-subscription ratio indicates a number of AI accelerators that are allowed to transmit information simultaneously over a Tier0 Ethernet switch. If the number of AI accelerators that attempt to transmit over the Tier0 Ethernet switch simultaneously is greater than the over-subscription ratio of the Tier0 Ethernet switch, traffic congestion (e.g., throttling) is likely to occur at the Tier0 Ethernet switch. Such congestion introduces latency in transmission of the information over the Tier0 Ethernet switch, which is likely to delay completion of a task that the AI system is attempting to complete. A user who requests performance of the task often is unaware of hardware constraints of the AI system and therefore is unlikely to know over-subscription ratios of Tier0 Ethernet switches associated with the AI system.

### SUMMARY

It may be desirable to reduce an amount of time that is consumed by an AI system to complete a task by more efficiently utilizing bandwidth associated with input/output (I/O) links that connect a Tier0 Ethernet switch to a Tier1 Ethernet switch. In an aspect, the efficiency with which the bandwidth is utilized is increased by generating a sharding scheme based on (e.g., based at least on) the over-subscription ratio of the Tier0 Ethernet switch. In an example, the sharding scheme ensures that AI accelerators in the AI system remain in continuous operation from one operation to the next. For instance, the sharding scheme may prevent the AI accelerators from sitting idle to wait for their next operations to queue. Accordingly, it may be said that the communication (i.e., receipt of the next operation) is hidden behind the computation (i.e., the present operation). In another example, the sharding scheme allocates operations that are to be performed by the AI accelerators among timeslots in a manner that causes a maximum bandwidth associated with the I/O links to be utilized.

Various approaches are described herein for, among other things, performing over-subscription ratio-based sharding in an AI system. In an example approach, a consensus regarding allocation of a workload associated with a task among a plurality of first AI accelerators is established by the plurality of first AI accelerators. The consensus is established by communicating between a plurality of subsets of the plurality of first AI accelerators via a plurality of network interface controllers associated with the plurality of subsets. The consensus indicates a plurality of portions of data that are to be transmitted by the plurality of first AI accelerators to a plurality of second AI accelerators in a second rack of the AI system via a Tier1 switch as a result of a plurality of sub-tasks performed by the plurality of first AI accelerators. The task includes the plurality of sub-tasks. The consensus further indicates a plurality of time durations that are to be consumed by transmission of the plurality of portions of the data. An AI input, which requests performance of the task, is received at the AI system. An AI response to the AI input is generated by the AI system. Generation of the AI response includes grouping the plurality of portions of the data into a plurality of shards corresponding to a plurality of respective timeslots by the plurality of first AI accelerators. The plurality of portions of the data are grouped into the plurality of shards based at least on the plurality of time durations and an over-subscription ratio associated with the plurality of first AI accelerators by limiting each of a plurality of sizes of the plurality of shards to be less than or equal to a maximum size. The maximum size is based at least on a maximum bandwidth associated with a plurality of input/output links that connect a Tier0 switch associated with the plurality of first AI accelerators to the Tier1 switch. The plurality of shards are transmitted in the plurality of respective timeslots to the plurality of second AI accelerators in the second rack via the Tier1 switch by designated first AI accelerators in the plurality of first AI accelerators.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example over-subscription ratio-based sharding system in accordance with an embodiment.

FIG. 2 is a block diagram of an example over-subscription ratio-based sharding AI system showing communication between network interface controllers (NICs) in respective AI accelerator trays that share a common Tier0 Ethernet switch in accordance with an embodiment.

FIG. 3 is a block diagram of an example over-subscription ratio-based sharding AI system in which AI accelerators in AI accelerator trays of a rack establish consensus by communicating via respective network interface controllers and a frontend top-of-rack (ToR) switch in accordance with an embodiment.

FIG. 4 is a block diagram of an example over-subscription ratio-based sharding AI system that includes multiple racks associated with respective Tier0 Ethernet switches that are connected to a common Tier1 Ethernet switch by respective sets of I/O links in accordance with an embodiment.

FIG. 5 depicts a flowchart of an example method for performing over-subscription ratio-based sharding in an AI system in accordance with an embodiment.

FIG. 6 depicts a flowchart of an example method for grouping a plurality of portions of data into a plurality of shards in accordance with an embodiment.

FIG. 7 is a block diagram of an example partitioned execution graph in accordance with an embodiment.

FIG. 8 is a block diagram of states of an execution graph as the execution graph is converted and partitioned in accordance with an embodiment.

FIG. 9 is a system diagram of an example mobile device in accordance with an embodiment.

FIG. 10 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to reduce an amount of time that is consumed by an AI system to complete a task by more efficiently utilizing bandwidth associated with input/output (I/O) links that connect a Tier0 Ethernet switch to a Tier1 Ethernet switch. In an aspect, the efficiency with which the bandwidth is utilized is increased by generating a sharding scheme based on (e.g., based at least on) the over-subscription ratio of the Tier0 Ethernet switch. In an example, the sharding scheme ensures that AI accelerators in the AI system remain in continuous operation from one operation to the next. For instance, the sharding scheme may prevent the AI accelerators from sitting idle to wait for their next operations to queue. Accordingly, it may be said that the communication (i.e., receipt of the next operation) is hidden behind the computation (i.e., the present operation). In another example, the sharding scheme allocates operations that are to be performed by the AI accelerators among timeslots in a manner that causes a maximum bandwidth associated with the I/O links to be utilized.

Example embodiments described herein are capable of performing over-subscription ratio-based sharding in an AI system. Example techniques described herein have a variety of benefits as compared to conventional techniques for sharding data in an AI system. For instance, the example techniques are capable of reducing an amount of time and/or resources (e.g., processor cycles, memory, network bandwidth) that is consumed by an AI system (and therefore a computing system that includes the AI system) to perform a task (e.g., matrix multiplication operations that are included in the task). For instance, by establishing, by a plurality of first AI accelerators in a first rack of an AI system, a consensus regarding allocation of a workload associated with a task among the plurality of first AI accelerators by communicating between a plurality of subsets of the plurality of first AI accelerators via a plurality of network interface controllers associated with the plurality of subsets; grouping, by the plurality of first AI accelerators, a plurality of portions of data indicated by the consensus into a plurality of shards corresponding to a plurality of respective timeslots based at least on a plurality of time durations indicated by the consensus and an over-subscription ratio associated with the plurality of first AI accelerators (e.g., by limiting each of a plurality of sizes of the plurality of shards to be less than or equal to a maximum size that is based at least on a maximum bandwidth associated with a plurality of input/output links that connect a Tier0 switch associated with the plurality of first AI accelerators to a Tier1 switch; and/or transmitting, by designated first AI accelerators in the plurality of first AI accelerators, the plurality of shards in the plurality of respective timeslots to a plurality of second AI accelerators in a second rack via the Tier1 switch, the amount of time and/or resources that is consumed by the AI system to perform the task is reduced.

In an aspect, the amount of time and/or resources that is consumed by the AI model to perform the task is reduced by consuming, by each of the designated first AI accelerators, the maximum bandwidth associated with the plurality of input/output links that connect the Tier0 switch associated with the plurality of first AI accelerators to the Tier1 switch during transmission of the respective shard in the respective timeslot.

In another aspect, the amount of time and/or resources that is consumed by the AI model to perform the task is reduced by converting, by the plurality of first AI accelerators, an execution graph associated with the task into a converted execution graph. The execution graph is converted by performing a graph coloring technique on the execution graph, which clusters a plurality of vertices that represent the plurality of sub-tasks into a plurality of clusters associated with a plurality of colors and forms an edge between each pair of vertices in each cluster that correspond to non-overlapping timeslots. In accordance with this aspect, the amount of time and/or resources that is consumed by the AI model to perform the task is reduced by generating, by the plurality of first AI accelerators, a plurality of cluster portions by partitioning each of the plurality of clusters. The plurality of cluster portions correspond to the plurality of shards.

By reducing the amount of time and/or resources that is consumed by the AI system to perform the task, the efficiency of the AI system (and therefore the computing system that includes the AI system) is increased. By reducing the amount of time and/or resources that is consumed, a cost associated with performing the task is reduced.

By reducing the amount of time and/or resources that is consumed by the AI system to perform the task, the example techniques may increase a user experience and/or efficiency of a user (e.g., an end user) of the AI system. By reducing the amount of time and/or resources that is consumed by the AI system to perform the task, the example techniques may increase a user experience and/or efficiency of an engineer or an information technology (IT) professional who manages the AI system. For instance, the example techniques may reduce a number of actions that are performed (e.g., manually performed) by the engineer or IT professional to reduce the amount of time and/or resources that is consumed by the AI system to perform the task. The example techniques are capable of automating such tasks. In an aspect, the example techniques reduce the number of actions performed by an engineer or IT professional to increase efficiency with which bandwidth associated with I/O links between a Tier0 Ethernet link and a Tier1 Ethernet link is utilized.

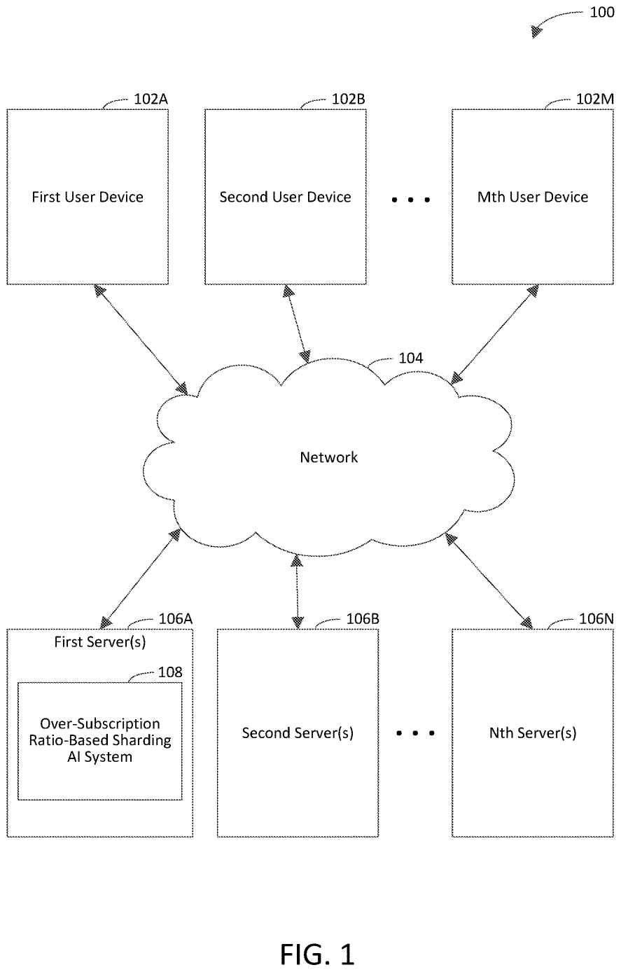

FIG. 1 is a block diagram of an example over-subscription ratio-based sharding system 100 in accordance with an embodiment. Generally speaking, the over-subscription ratio-based sharding system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the over-subscription ratio-based sharding system 100 performs over-subscription ratio-based sharding in an AI system. Detail regarding techniques for performing over-subscription ratio-based sharding in an AI system is provided in the following discussion.

As shown in FIG. 1, the over-subscription ratio-based sharding system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors. In an example, the one or more processors are on a same (e.g., single) device. In another example, the one or more processors are distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. In an example, a user initiates a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M are able to access information that is available via the domains. In an aspect, the domain include Web page(s). In an example, the Web page(s) are provided as hypertext markup language (HTML) documents and objects (e.g., files) that are linked therein.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. In an example, the information includes documents (Web pages, images, audio files, video files, etc.), output of executables, or any other suitable type of information. In accordance with some example embodiments, the servers 106A-106N are configured to host respective Web sites, so that the Web sites are accessible to users of the over-subscription ratio-based sharding system 100.

One example type of computer program that may be executed by one or more of the servers 106A-106N is a cloud computing program (e.g., a cloud service). A cloud computing program is a computer program that provides hosted service(s) via a network (e.g., network 104). In an example, the hosted service(s) are hosted by any one or more of the servers 106A-106N. In another example, the cloud computing program enables users (e.g., at any of the user systems 102A-102M) to access shared resources that are stored on or are otherwise accessible to the server(s) via the network.

In an aspect, the cloud computing program provides hosted service(s) according to a service model. Examples of a service model include but are not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an IaaS provider's computer infrastructure (e.g., to support an enterprise). In an example, IaaS provides to the user virtualized computing resources that utilize the IaaS provider's physical computer resources.

Examples of a cloud computing program include but are not limited to a Google Cloud® program developed and distributed by Google Inc.; an Oracle Cloud® program developed and distributed by Oracle Corporation; an Amazon Web Services® program developed and distributed by Amazon.com, Inc.; a Salesforce® program developed and distributed by Salesforce.com, Inc.; an AppSource® program developed and distributed by Microsoft Corporation; an Azure® program developed and distributed by Microsoft Corporation; a GoDaddy® program developed and distributed by GoDaddy.com LLC; and a Rackspace® program developed and distributed by Rackspace US, Inc. In an aspect, one or more of the example techniques described herein are implemented using a cloud computing program. In an example, a software product (e.g., a subscription service, a non-subscription service, or a combination thereof) includes the cloud computing program, and the software product is configured to perform the example techniques.

Another example type of a computer program that may be executed by one or more of the servers 106A-106N is an AI model. An AI model is a model that utilizes artificial intelligence to perform a task in response to an AI input that is received by the AI model. Artificial intelligence is intelligence of a machine (e.g., a computing system) and/or code (e.g., software and/or firmware), as opposed to intelligence of a living creature (e.g., a human). In an aspect, the AI model is an artificial general intelligence model. An artificial general intelligence model is an AI model (e.g., an autonomous AI model) that is configured to be capable of performing any task that an intelligent being (e.g., a human) is capable of performing. In an example implementation, the artificial general intelligence model is capable of performing a task that surpasses the capabilities of an animal.

In an aspect, the AI model includes (e.g., is) a generative language model. A generative language model is an AI model that is capable of generating original text output based on sample data. Examples of a generative language model include but are not limited to a generative pre-trained transformer 3 (GPT-3®) model and a generative pre-trained transformer 4 (GPT-4®) model, developed and distributed by OpenAI, Inc.; a Phi™ model and a Turing-NLG™ model, developed and distributed by Microsoft Corporation; a large language model Meta AI (LLaMA®) model, developed and distributed by Meta Platforms Inc.; a language model for dialogue applications (LaMDA®) model and a Gemini® model, developed and distributed by Google LLC; and a BigScience large open-science open-access multilingual language model (BLOOM) model, developed and distributed by the BigScience collaborative initiative. A generative language model may use any suitable relevancy determination and/or ranking technique. In an example, the generative language model uses a BM25 (Okapi BM25) ranking function to perform its analysis (e.g., based on keywords).

In another aspect, the AI model includes a large language model (LLM). A large language model is an artificial neural network that is capable of performing natural language processing (NLP) tasks. In an example, the large language model uses a transformer model to perform the NLP tasks. In another example, the large language model is trained (e.g., pre-trained) using self-supervised learning and semi-supervised learning. Examples of a large language model include but are not limited to the GPT-3® and GPT-4® models, developed and distributed by OpenAI, Inc.; the LLaMA® model, developed and distributed by Meta Platforms Inc.; and a pathways language model (PaLM®) model and the Gemini® model, developed and distributed by Google LLC.

In yet another aspect, the AI model includes an embedding model. An embedding model is an AI model that uses deep learning to convert data into vectors, which represent attributes of the data, and that compares at least a subset of the vectors to determine an extent to which the vectors that are included in the subset are similar. In an example, each vector represents a semantic meaning of one or more AI inputs, one or more items referenced in the one or more AI inputs, or one or more AI responses to the one or more AI inputs. In an example implementation, the embedding model is an encoder-only model. One example of an encoder-only model is the bidirectional encoder representations from transformers (BERT™) model, which is developed and distributed by Google LLC. In another example implementation, the embedding model is a decoder-only model. In yet another example implementation, the embedding model is an encoder-decoder model. One example of an encoder-decoder model is the FLAN-T5™ model, which is developed and distributed by Google LLC.

In still another aspect, the AI model includes multiple types of AI models. In accordance with this aspect, weights may be applied to responses generated by respective types of AI models. In an example, the AI model includes a generative AI model and an embedding model. In accordance with this example, a first weight is applied to a first response generated by the generative AI model to provide a first weighted response, and a second weight that is different from the first weight is applied to a second response of the embedding model to provide a second weighted response. In further accordance with this example, the AI model combines (e.g., sums) the first weighted response and the second weighted response to generate a response of the AI model.

An AI input indicates (e.g., specifies) a task that is to be performed by an AI model. Examples of an AI input include but are not limited to an AI prompt and an application programming interface (API) input. An AI prompt is an AI input that causes (e.g., triggers) an AI model to generate an answer that is responsive to the AI prompt. An answer to an AI prompt is referred to herein as an “AI response.” Examples of an AI prompt include but are not limited to a zero-shot prompt, a one-shot prompt, and a few-shot prompt. A zero-shot prompt is a prompt that indicates a task to be performed by an AI model that has not been trained on example(s) of the task. A one-shot prompt is a prompt that includes a target prompt along with a single example prompt and a single example answer that is responsive to the single example prompt. The example prompt and the example answer provide guidance as to how the AI model is expected to respond to the target prompt. A few-shot prompt is a prompt that includes a target prompt along with multiple example prompts and multiple example answers that are responsive to the respective example prompts. The example prompts and the example answers provide guidance as to how the AI model is expected to respond to the target prompt.

In an example, an AI prompt is a natural language prompt. A natural language prompt is a prompt that is written in a natural language. A natural language is a human language that has developed through use and repetition. In an example, the natural language has developed naturally without conscious planning or premeditation. Examples of a natural language include English, French, Spanish, and Mandarin. In an aspect, the natural language prompt is generated by a user (e.g., a human). In another aspect, the natural language prompt is generated by a computing system (e.g., an AI assistant that runs on the computing system).

In another example, an AI prompt is not written in a natural language. In an implementation of this example, the AI prompt includes (e.g., is) computer code. The AI prompt may be any suitable sequence of characters that is capable of being interpreted by an AI model.

An API input is an AI input that is provided via an API to request a service or a function. An API is an interface between a computing system and code (e.g., software or firmware).

The first server(s) 106A are shown to include over-subscription ratio-based sharding AI system 108 for illustrative purposes. The over-subscription ratio-based sharding AI system 108 is configured to perform over-subscription ratio-based sharding. In an example implementation, the over-subscription ratio-based sharding AI system 108 establishes a consensus regarding allocation of a workload associated with a task among a plurality of first AI accelerators. The consensus is established by subsets of the plurality of first AI accelerators communicating via a plurality of network interface controllers associated with the plurality of subsets. The consensus indicates a plurality of portions of data that are to be transmitted by the plurality of first AI accelerators to a plurality of second AI accelerators in a second rack of the AI system via a Tier1 switch as a result of a plurality of sub-tasks performed by the plurality of first AI accelerators. The task includes the plurality of sub-tasks. The consensus further indicates a plurality of time durations that are to be consumed by transmission of the plurality of portions of the data. The over-subscription ratio-based sharding AI system 108 receives an AI input, which requests performance of the task. The over-subscription ratio-based sharding AI system 108 generates an AI response to the AI input. To generate the AI response, the over-subscription ratio-based sharding AI system 108 groups the plurality of portions of the data into a plurality of shards corresponding to a plurality of respective timeslots. The plurality of portions of the data are grouped into the plurality of shards based at least on the plurality of time durations and an over-subscription ratio associated with the plurality of first AI accelerators by limiting each of a plurality of sizes of the plurality of shards to be less than or equal to a maximum size. The maximum size is based at least on a maximum bandwidth associated with a plurality of input/output links that connect a Tier0 switch associated with the plurality of first AI accelerators to the Tier1 switch. To generate the AI response, the over-subscription ratio-based sharding AI system 108 further transmits the plurality of shards in the plurality of respective timeslots to the plurality of second AI accelerators in the second rack via the Tier1 switch. In an aspect, the over-subscription ratio-based sharding AI system 108 implements an AI model to perform any one or more of the aforementioned operations.

In an aspect, the over-subscription ratio-based sharding AI system 108 executes an AI model to perform the task. In an example of this aspect, the over-subscription ratio-based sharding AI system 108 analyzes (e.g., develops and/or refines an understanding of) the plurality of portions of data that are to be transmitted by the plurality of first AI accelerators, the plurality of time durations that are to be consumed by transmission of the plurality of portions of the data, the over-subscription ratio associated with the plurality of first AI accelerators, the maximum bandwidth associated with the plurality of input/output links that connect the Tier0 switch associated with the plurality of first AI accelerators to the Tier1 switch, relationships between any of the foregoing, and confidences in those relationships (e.g., to group the plurality of portions of the data into the plurality of shards that correspond to the plurality of respective timeslots) using the AI model. In an example, the over-subscription ratio-based sharding AI system 108 further analyzes sample portions of data, sample time durations, sample over-subscription ratios, and sample maximum bandwidths (e.g., to group the plurality of portions of the data into the plurality of shards) using the AI model.

It will be recognized that the over-subscription ratio-based sharding AI system 108 may be (or may be included in) a cloud computing system, though the scope of the example embodiments is not limited in this respect. A cloud computing system is a system that implements (e.g., executes) a cloud computing program.

The over-subscription ratio-based sharding AI system 108 may be implemented in various ways to perform over-subscription ratio-based sharding, including being implemented in hardware, software, firmware, or any combination thereof. For example, the over-subscription ratio-based sharding AI system 108 may be implemented as computer program code configured to be executed in one or more processors. In another example, at least a portion of the over-subscription ratio-based sharding AI system 108 may be implemented as hardware logic (e.g., electrical circuitry). For instance, at least a portion of the over-subscription ratio-based sharding AI system 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

The over-subscription ratio-based sharding AI system 108 is shown to be incorporated in the first server(s) 106A for illustrative purposes and is not intended to be limiting. It will be recognized that the over-subscription ratio-based sharding AI system 108 (or any portion(s) thereof) may be incorporated in any one or more of the servers 106A-106N, any one or more of the user devices 102A-102M, or any combination thereof. For example, client-side aspects of the over-subscription ratio-based sharding AI system 108 may be incorporated in one or more of the user devices 102A-102M, and server-side aspects of the over-subscription ratio-based sharding AI system 108 may be incorporated in one or more of the servers 106A-106N.

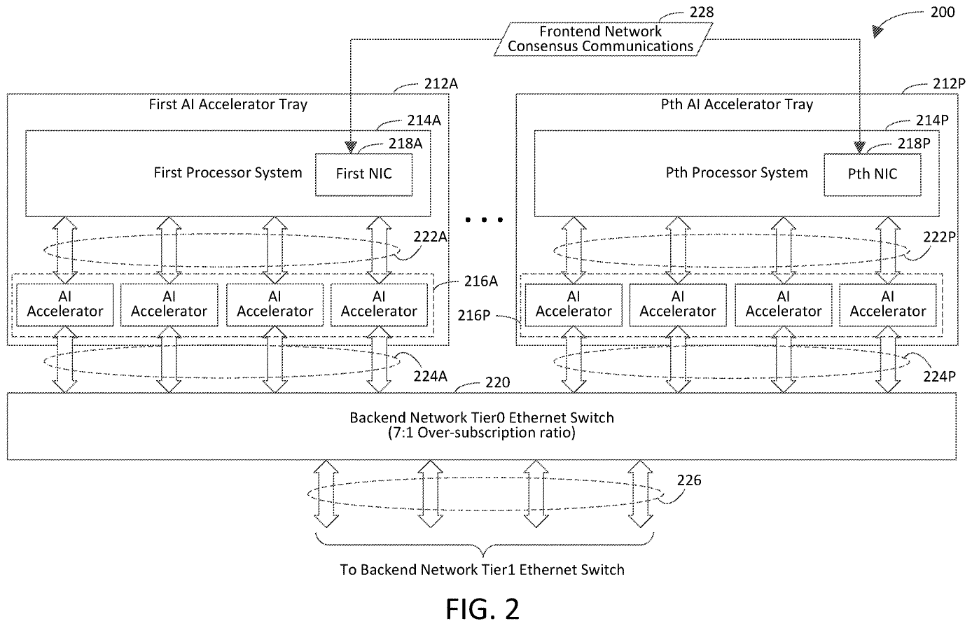

FIG. 2 is a block diagram of an example over-subscription ratio-based sharding AI system 200 showing communication between network interface controllers (NICs) in respective AI accelerator trays that share a common Tier0 Ethernet switch in accordance with an embodiment. The over-subscription ratio-based sharding AI system 200 is an example implementation of the over-subscription ratio-based sharding AI system 108 shown in FIG. 1. As shown in FIG. 2, the over-subscription ratio-based sharding AI system 200 includes a plurality of AI accelerator trays 212A-212P and a backend network Tier0 Ethernet switch 220. The AI accelerator trays 212A-212P includes respective processor systems 214A-214P and respective subsets 216A-216P of a plurality of AI accelerators. The processor systems 214A-214P are associated with respective NICs 218A-218P, which will be discussed in further detail below.

The processor systems 214A-214P are connected to respective subsets 216A-216P of a plurality of AI accelerators via respective subsets 222A-222P of a plurality of serial links (e.g., high speed serial links). In an aspect, the plurality of serial links are Peripheral Component Interconnect Express (PCIe®) links. The subsets 216A-216P of a plurality of AI accelerators are connected to the backend network Tier0 Ethernet switch 220 via respective subsets 224A-224P of a plurality of I/O links. The backend network Tier0 Ethernet switch 220 is connected to a backend network Tier1 Ethernet switch (not shown) via a second plurality of I/O links 226. The backend network Tier0 Ethernet switch 220 aggregates information received from the subsets 216A-216P of the plurality of AI accelerators via the respective subsets 224A-224P of the plurality of I/O links to provide aggregated information, which is sent to AI accelerator tray(s) associated with another backend network Tier0 Ethernet switch via the backend network Tier1 Ethernet switch.

The backend network Tier0 Ethernet switch 220 is shown in FIG. 2 to have an over-subscription ratio of 7:1 for non-limiting illustrative purposes. The over-subscription ratio of 7:1 indicates that seven AI accelerators in the plurality of AI indicators are allowed to transmit information simultaneously over the backend network Tier0 Ethernet switch 220. It will be recognized that the over-subscription ratio may be any suitable ratio (e.g., 4:1, 6:1, or 13:2). In an aspect, the over-subscription ratio depends on a configuration of the backend network Tier0 Ethernet switch 220.

The subsets 216A-216P of the plurality of AI accelerators communicate via the respective NICs 218A-218P to establish consensus regarding allocation of a workload among the plurality of AI accelerators. The workload is associated with a task that is to be performed by the over-subscription ratio-based sharding AI system 200 in response to an AI input that is received by the over-subscription ratio-based sharding AI system 200. For illustrative purposes, FIG. 2 shows frontend network consensus communication 228 being exchanged between the first NIC 218A and the Pth NIC 218P. By communicating via the NICs 218A-218P, the plurality of AI accelerators reach a consensus regarding how a workload associated with a task is to be allocated among the plurality of AI accelerators. In an aspect, the plurality of AI accelerators execute a plurality of respective instances of a consensus algorithm to reach the consensus. A consensus algorithm is an algorithm that is configured to perform consensus among multiple unreliable entities (e.g., AI accelerators). Consensus is a process by which the multiple unreliable entities agree on a common (e.g., same or single) result. In an example of this aspect, the plurality of AI accelerators determine respective portions of the workflow to be performed by respective AI accelerators in the plurality of AI accelerators in accordance with the consensus algorithm.

By knowing the portions of the workflow that are to be performed by the respective AI accelerators, the plurality of AI accelerators can determine portions of data that the respective AI accelerators are to transmit to other AI accelerator(s) via the backend network Tier0 Ethernet switch 220 and the backend network Tier1 Ethernet switch. In an aspect, the consensus indicates the portions of the data (e.g., including amounts of the data in the respective portions) and amounts of time that are to be consumed to transmit the respective portions of the data. By knowing the portions of the data, the amounts of time that are to be consumed to transmit the respective portions of the data, and an over-subscription ratio associated with the plurality of AI accelerators, the plurality of AI accelerators can group the portions of the data into shards that correspond to respective timeslots for transmission over the backend network Tier0 Ethernet switch 220 and the backend network Tier1 Ethernet switch.

In the embodiment of FIG. 2, each of the subsets 222A-222P of the plurality of serial links includes four serial links for non-limiting illustrative purposes. It will be recognized that each of the subsets 222A-222P may include any suitable number of serial links (e.g., 2, 4, 8, 12, or 16). In the embodiment of FIG. 2, each of the subsets 216A-216P of the plurality of AI accelerators includes four AI accelerators for non-limiting illustrative purposes. It will be recognized that each of the subsets 216A-216P may include any suitable number of AI accelerators (e.g., 2, 4, 8, 12, or 16). In the embodiment of FIG. 2, each of the subsets 224A-224P of the plurality of I/O links includes four I/O links for non-limiting illustrative purposes. It will be recognized that each of the subsets 224A-224P may include any suitable number of I/O links (e.g., 2, 4, 8, 12, or 16). In the embodiment of FIG. 2, the second plurality of I/O links 226 includes four I/O links for non-limiting illustrative purposes. It will be recognized that the second plurality of I/O links 226 may include any suitable number of I/O links (e.g., 2, 4, 8, 12, or 16).

It will be recognized that the over-subscription ratio-based sharding AI system 200 need not necessarily include the backend network Tier0 Ethernet switch 220, the subsets 224A-224P of the plurality of I/O links, and/or the second plurality of I/O links 226.

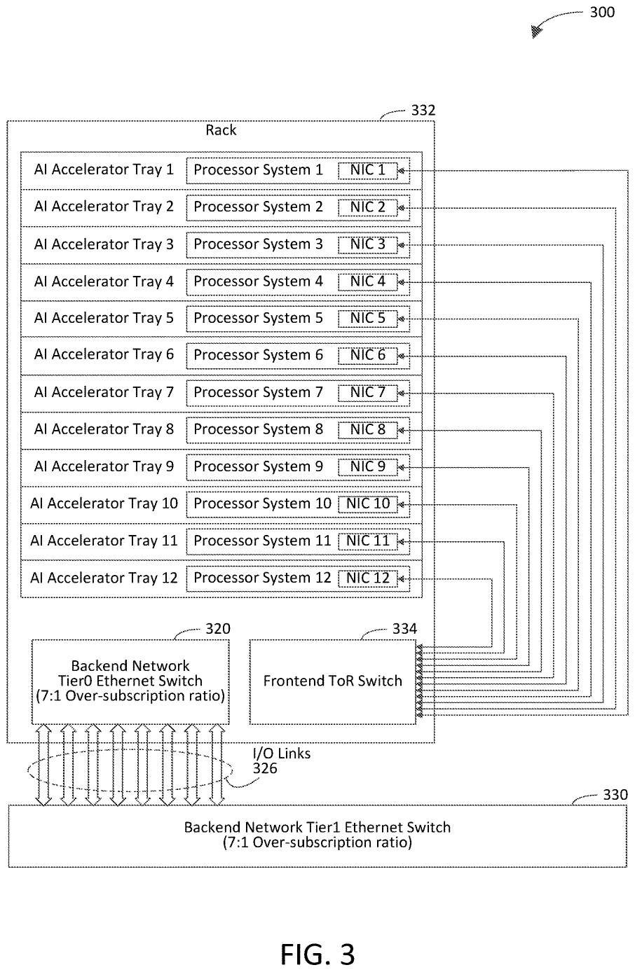

FIG. 3 is a block diagram of an example over-subscription ratio-based sharding AI system 300 in which AI accelerators in AI accelerator trays of a rack establish consensus by communicating via respective network interface controllers and a frontend top-of-rack (ToR) switch in accordance with an embodiment. The over-subscription ratio-based sharding AI system 300 is another example implementation of the over-subscription ratio-based sharding AI system 108 shown in FIG. 1. As shown in FIG. 3, the over-subscription ratio-based sharding AI system 300 includes a rack 332 and a backend network Tier1 Ethernet Switch 330. The rack 332 includes AI accelerator trays 1-12, a backend network Tier0 Ethernet switch 320 and a frontend ToR switch 334. The AI accelerator trays 1-12 include respective processor systems 1-12. The processor systems 1-12 include respective NICs 1-12. The backend network Tier0 Ethernet switch 320 is connected to the backend network Tier1 Ethernet switch 330 via I/O links 326. The frontend ToR switch 334 routes consensus communications between the NICs 1-12. In an aspect, AI accelerators in the AI accelerator trays 1-12 establish consensus regarding allocation of a workload associated with a task among the AI accelerators by communicating through the frontend ToR switch 334.

The backend network Tier0 Ethernet switch 320 is shown in FIG. 3 to have an over-subscription ratio of 7:1 for non-limiting illustrative purposes. It will be recognized that the over-subscription ratio may be any suitable ratio (e.g., 4:1, 12:1, or 15:1). In an aspect, the over-subscription ratio is set by a configuration of the backend network Tier0 Ethernet switch 320.

It will be recognized that the rack 332 need not necessarily include the backend network Tier0 Ethernet switch 320. It will be further recognized that the over-subscription ratio-based sharding AI system 300 need not necessarily include the backend network Tier0 Ethernet switch 320, the I/O links 326, and/or the backend network Tier1 Ethernet switch 330.

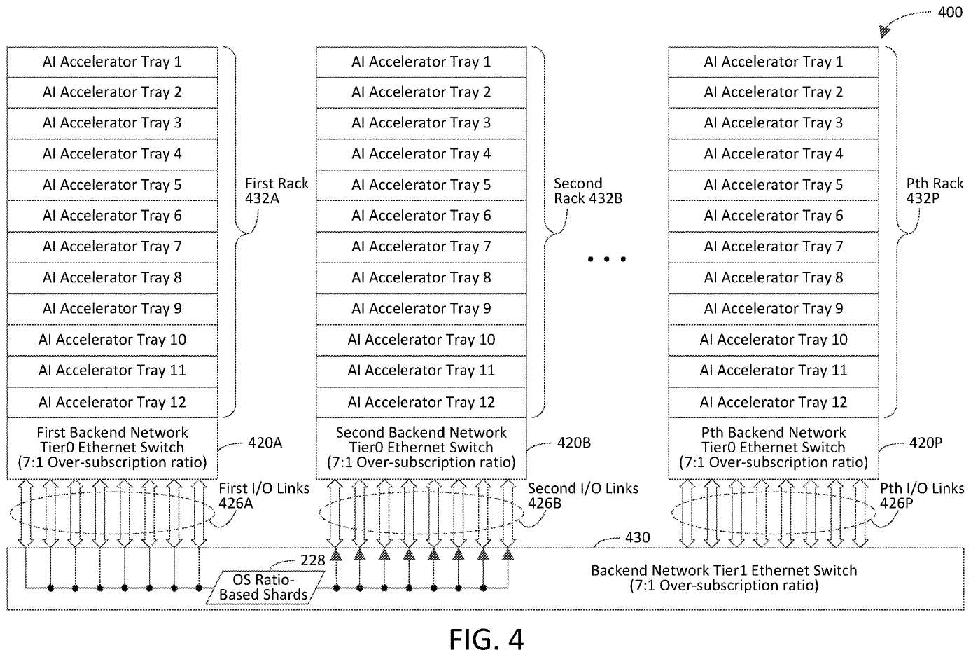

FIG. 4 is a block diagram of an example over-subscription ratio-based sharding AI system 400 that includes multiple racks associated with respective Tier0 Ethernet switches that are connected to a common Tier1 Ethernet switch by respective sets of I/O links in accordance with an embodiment. The over-subscription ratio-based sharding AI system 400 is yet another example implementation of the over-subscription ratio-based sharding AI system 108 shown in FIG. 1. As shown in FIG. 4, the over-subscription ratio-based sharding AI system 400 includes a plurality of AI accelerator racks 432A-432P, a plurality of backend network Tier0 Ethernet switches 420A-420P, and a backend network Tier1 Ethernet switch 430. Each of the plurality of AI accelerator racks 432A-432P is shown to include twelve (12) AI accelerator trays for non-limiting illustrative purposes. It will be recognized that each of the plurality of AI accelerator racks 432A-432P may include any suitable number of AI accelerator trays (e.g., 8, 12, 16, or 32).

The plurality of AI accelerator racks 432A-432P are connected to the plurality of respective backend network Tier0 Ethernet switches 420A-420P. For example, a first rack 423A is connected to a first backend network Tier0 Ethernet switch 420A; a second rack 432B is connected to a second backend network Tier0 Ethernet switch 420B, and so on. The plurality of backend network Tier0 Ethernet switches 420A-420P route traffic from the plurality of respective AI accelerator racks 432A-432P to the backend network Tier1 Ethernet switch 430 via a plurality of respective subsets of a plurality of I/O links. For example, the first backend network Tier0 Ethernet switch 420A routes first traffic from the first rack 432A to the backend network Tier1 Ethernet switch 430 via a first subset of the plurality of I/O links (labeled as “first I/O links 426A”); the second backend network Tier0 Ethernet switch 420B routes second traffic from the second rack 432B to the backend network Tier1 Ethernet switch 430 via a second subset of the plurality of I/O links (labeled as “second I/O links 426B”), and so on.

A plurality of AI accelerators are distributed among the AI accelerator trays in the plurality of racks 432A-432P. Accelerator trays in the first rack 432A include a first subset of the plurality of AI accelerators; accelerator trays in the second rack 432B include a second subset of the plurality of AI accelerators, and so on. AI accelerators in the first rack 432A establish consensus regarding allocation of a workload among the AI accelerators in the first rack 432A based at least on an over-subscription ratio associated with the AI accelerators in the first rack 432A. The over-subscription ratio associated with each of the backend network Tier0 Ethernet switches 420A-420P is shown in FIG. 4 to be 7:1 for non-limiting illustrative purposes. It will be recognized that the over-subscription ratio may be any suitable ratio (e.g., 5:1, 10:1, or 11:2). In an aspect, the over-subscription ratio is based on a configuration of the first backend network Tier0 Ethernet switch 420A. The workload is associated with a task to be performed by the over-subscription ratio-based sharding AI system 400.

After establishing the consensus, the AI accelerators in the first rack 432A group portions of data indicated by the consensus into over-subscription ratio-based shards (labeled as “OS ratio-based shards”) 228 for transmission to AI accelerators in the second rack 432B. The AI accelerators in the first rack 432A provide the over-subscription ratio-based shards 228 to the AI accelerators in the second rack 432B via a path that includes (in order) the first backend network Tier0 Ethernet switch 420A, the first I/O links 426A, the backend network Tier1 Ethernet switch 430, the second I/O links 426B, and the second backend network Tier0 Ethernet switch 420B. For example, the AI accelerators in the first rack 432A provide the over-subscription ratio-based shards 228 to the first backend network Tier0 Ethernet switch 420A. The first backend network Tier0 Ethernet switch 420A routes the over-subscription ratio-based shards 228 to the backend network Tier1 Ethernet switch 430 via the first I/O links 426A. The backend network Tier1 Ethernet switch 430 routes the over-subscription ratio-based shards 228 to the second backend network Tier0 Ethernet switch 420B via the second I/O links 426B. The second backend network Tier0 Ethernet switch 420B provides the over-subscription ratio-based shards 228 to the AI accelerators in the second rack 432B.

In an example embodiment, the AI accelerators in the first rack 432A provide the over-subscription ratio-based shards 228 to the AI accelerators in the second rack 432B in respective timeslots that correspond to the respective AI accelerator trays 1-12. In an aspect, a first shard is provided in a first timeslot assigned to AI accelerator tray 1; a second shard is provided in a second timeslot assigned to AI accelerator 2, and so on. In another aspect, an entirety of a bandwidth (e.g., a maximum bandwidth) associated with the first I/O links 426A is utilized for each of the respective timeslots. It will be recognized that the bandwidth associated with the first I/O links 426A is also associated with the AI accelerators in the first rack 432A (e.g., as a result of the first I/O links 426A connecting the first backend network Tier0 Ethernet switch 420A, which corresponds to the first rack 432A, to the backend network Tier1 Ethernet switch 430).

It will be recognized that the over-subscription ratio-based sharding AI system 400 need not necessarily include the backend network Tier0 Ethernet switches 420A-420P, the plurality of I/O links 426A-426P, and/or the backend network Tier1 Ethernet switch 430.

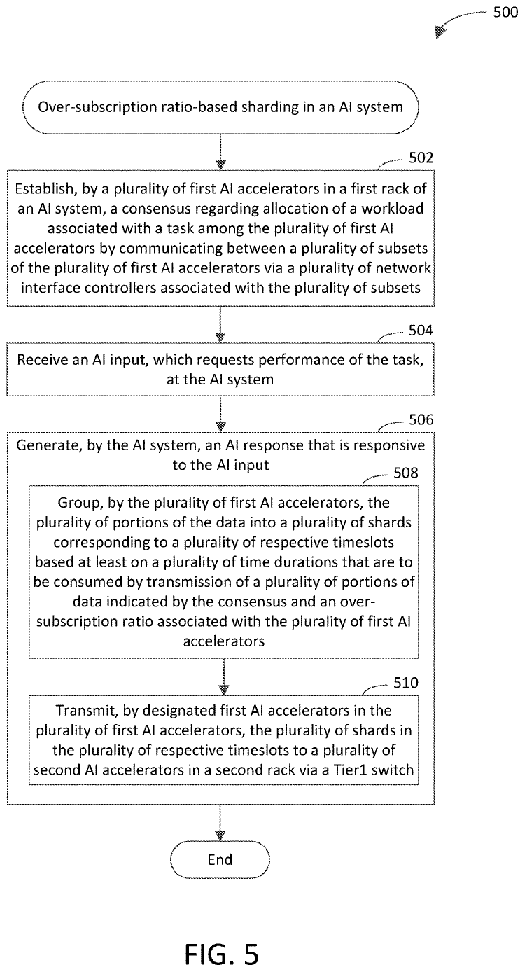

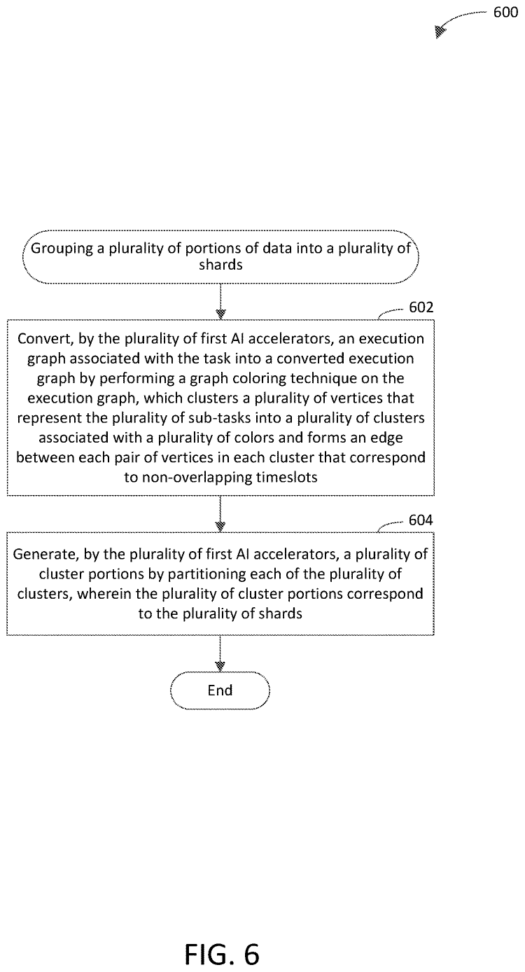

FIG. 5 depicts a flowchart 500 of an example method for performing over-subscription ratio-based sharding in an AI system in accordance with an embodiment. FIG. 6 depicts a flowchart 600 of an example method for grouping a plurality of portions of data into a plurality of shards in accordance with an embodiment. Flowcharts 500 and 600 may be performed by the first server(s) 106A shown in FIG. 1, for example. In an aspect, flowcharts 500 and 600 are performed by the over-subscription ratio-based sharding AI system 108, which is included in the first server(s) 106A. For illustrative purposes, flowcharts 500 and 600 are described with respect to the over-subscription ratio-based sharding AI system 200 shown in FIG. 2. Further structural and operational embodiments will be apparent to persons skilled in the relevant art(s) based on the discussion regarding flowcharts 500 and 600.

As shown in FIG. 5, the method of flowchart 500 begins at step 502. In step 502, a consensus regarding allocation of a workload associated with a task among a plurality of first AI accelerators in a first rack of an AI system is established by the plurality of first AI accelerators. The consensus is established by communication between a plurality of subsets of the plurality of first AI accelerators via a plurality of network interface controllers (NICs) associated with the plurality of subsets. The consensus indicates a plurality of portions of data that are to be transmitted by the plurality of first AI accelerators to a plurality of second AI accelerators in a second rack of the AI system via a Tier1 switch as a result of a plurality of sub-tasks performed by the plurality of first AI accelerators. The task includes the plurality of sub-tasks. The consensus further indicates a plurality of time durations that are to be consumed by transmission of the plurality of portions of the data. In an aspect, each sub-task is provisioned. In an example, by provisioning the plurality of sub-tasks, each of the sub-tasks is allocated and scheduled to be executed. Accordingly, the provisioning of the plurality of sub-tasks may ensure (e.g., guarantee) that the plurality of sub-tasks will be performed by the plurality of first AI accelerators. In an example implementation, the plurality of first AI accelerators includes subsets 216A-216P of the plurality of first AI accelerators. The first AI accelerators in the subsets 216A-216P establish the consensus among the plurality of first AI accelerators by communicating via NICs 218A-218P, which are associated with the subsets 216A-216P.

In an example embodiment, allocation of the workload includes parsing the workload into the plurality of sub-tasks. In an example, each sub-task includes a respective matrix multiplication operation and/or a respective convolution operation. A matrix multiplication operation is a mathematical operation that is configured to multiply a first matrix and a second matrix to provide a third matrix. One example of a matrix multiplication operation is a general matrix multiplication (GEMM) operation. A GEMM operation is a matrix multiplication operation that is configured (e.g., optimized) to be performed on a specific hardware architecture (e.g., an AI accelerator). In an example the GEMM leverages parallelism and efficient memory access patterns. In another example, the GEMM is implemented in a math library (a.k.a. a linear algebra library). Examples of a math library include but are not limited to a basic linear algebra subprogram (BLAS), a CUDA BLAS (a.k.a. cuBLAS), and a math kernel library (MKL). For instance, the GEMM operation may be used in a machine learning (e.g., deep learning), scientific computing, or simulation application. A convolution operation is a mathematical operation (e.g., process) in which a filter is slid over input data to provide a feature map. In an example, the feature map highlight aspect(s), such as edge(s), texture(s), and/or pattern(s).

In another example embodiment, the plurality of sub-tasks include respective pluralities of operations. In an example, a first sub-task includes a first plurality of operations; a second sub-task includes a second plurality of operations, and so on. In accordance with this embodiment, each first AI accelerator in the plurality of first AI accelerators receives an indication of a next successive operation in a respective plurality of operations, which is to be performed by the respective first AI accelerator, prior to the respective first AI accelerator completing an operation in the respective plurality of operations that precedes the next successive operation. In an aspect, a first AI accelerator receiving an indication of a next successive operation while the first AI accelerator is performing the operation that immediately precedes the next successive operation enables the first AI accelerator to avoid becoming idle from waiting for the next successive operation to be entered into a queue of the first AI accelerator. In another aspect, performing successive operations without a delay between the successive operations causes the task to be performed more quickly and/or efficiently.

At step 504, an AI input, which requests performance of the task, is received at the AI system. In an example implementation, any one or more of the NICs 218A-218P receive the AI input.

At step 506, an AI response that is responsive to the AI input is generated by the AI system. In an example implementation, any one or more of the first AI accelerators in the subsets 216A-216P generate the AI response.

Step 506 includes steps 508 and 510. At step 508, the plurality of portions of the data are grouped by the plurality of first AI accelerators into a plurality of shards corresponding to a plurality of respective timeslots based at least on the plurality of time durations and an over-subscription ratio associated with the plurality of first AI accelerators. In an aspect, the plurality of first AI accelerators groups the plurality of portions of the data into the plurality of shards by executing an AI model. In an example of this aspect, the plurality of first AI accelerators uses (e.g., causes, accelerates, or enables) the AI model to group the plurality of portions of the data into the plurality of shards. The plurality of portions of the data are grouped into the plurality of shards by limiting each of a plurality of sizes of the plurality of shards to be less than or equal to a maximum size that is based at least on a maximum bandwidth associated with a plurality of input/output links that connect a Tier0 switch associated with the plurality of first AI accelerators to the Tier1 switch. The maximum bandwidth may be referred to herein as the “full injection bandwidth” of the plurality of input/output links.

In an example implementation, the first AI accelerators in the subsets 216A-216P group the plurality of portions of the data into the plurality of shards based at least on the plurality of time durations and an over-subscription ratio associated with the first AI accelerators in the subsets 216A-216P. In accordance with this implementation, the first AI accelerators in the subsets 216A-216P group the plurality of portions of the data into the plurality of shards by limiting each of the plurality of sizes of the plurality of shards to be less than or equal to the maximum size. In further accordance with this implementation, the maximum size is based at least on a maximum bandwidth associated with I/O links 226, which connect a backend network Tier0 Ethernet switch 220 associated with the first AI accelerators in the subsets 216A-216P to a backend network Tier1 Ethernet switch.

In an example clustering embodiment, the first AI accelerators in the subsets 216A-216P group the plurality of portions of the data into the plurality of shards by clustering (e.g., partitioning) respective subsets of the plurality of portions of the data into respective categories (e.g., clusters). In an aspect, the first AI accelerators in the subsets 216A-216P clusters the respective subsets of the plurality of portions of the data into the respective categories as a result of the portion(s) of the data included in the respective subset in each cluster having attributes that satisfy a criterion. In an example of this aspect, the portion(s) of the data included in the respective subset in each cluster share a common (e.g., same) attribute or combination of attributes.

In an aspect of the clustering embodiment, the first AI accelerators in the subsets 216A-216P cluster the subsets of the plurality of portions of the data into the respective clusters by analyzing attributes of data items indicated by the plurality of portions of the data (e.g., embeddings that represent the data items or subsets thereof) using a clustering algorithm. The clustering algorithm may be density-based, distribution-based, centroid-based, or hierarchical-based. A density-based clustering algorithm clusters data points (e.g., the subsets of the communications), which are included in an area having a relatively high concentration of data points that is surrounded by area(s) having a relatively low concentration of data points, into a cluster. A distribution-based clustering algorithm clusters data points into clusters based on a distance of each data point to the center of each of multiple clusters, such that the data point is included in the cluster having a center that is closer to the data point than the center of each other cluster. A centroid-based clustering algorithm clusters data points into clusters based on a squared distance of each data point from each of multiple centroids in the data, such that the data point is included in the cluster corresponding to the centroid with the shortest squared distance to the data point. A hierarchical-based clustering algorithm clusters data points based on which of multiple hierarchical levels of a hierarchy includes the data points. For example, data points corresponding to a first hierarchical level are clustered into a first cluster; data points corresponding to a second hierarchical level are clustered into a second cluster, and so on.

In an example of this aspect, the subsets of the plurality of portions of the data are clustered into the respective clusters as a result of the subsets of the plurality of portions of the data corresponding to respective attributes. For instance, a first subset of the plurality of portions of the data may be clustered into a first cluster as a result of the data items in the first subset sharing first attribute(s). A second subset of the plurality of portions of the data may be clustered into a second cluster as a result of the data items in the second subset sharing second attribute(s), and so on. In another example, each cluster consists of a designated (e.g., fixed) number (e.g., 20, 1000, or 20,000) of the data items.

In yet another example of this aspect, the clustering algorithm is a K-means clustering algorithm. The K-means clustering algorithm is an unsupervised learning centroid-based clustering algorithm. In an aspect, the K-means clustering algorithm attempts to minimize the variance of data points within each cluster.

In still another example of this aspect, the clustering algorithm is a density-based spatial clustering of applications with noise (DBSCAN) clustering algorithm. As indicated by its name, the DBSCAN clustering algorithm is a density-based clustering algorithm. The DBSCAN clustering algorithm defines arbitrarily shaped clusters based on density of data points in regions that are separated by areas of low-density.

Other examples of a clustering algorithm include but are not limited to a Gaussian mixture clustering algorithm, a balance iterative reducing and clustering using hierarchies (BIRCH) clustering algorithm, an affinity propagation clustering algorithm, a mean-shifting clustering algorithm, an ordering points to identify the clustering structure (OPTICS) clustering algorithm, and an agglomerative hierarchy clustering algorithm.

In accordance with the embedding embodiment, the first AI accelerators in the subsets 216A-216P determine relationships between data items representing the plurality of portions of data that are to be transmitted by the plurality of first AI accelerators, the plurality of time durations that are to be consumed by transmission of the plurality of portions of the data, the over-subscription ratio associated with the plurality of first AI accelerators, and/or the maximum bandwidth associated with the plurality of input/output links that connect the Tier0 switch associated with the plurality of first AI accelerators to the Tier1 switch based on distances between embeddings (e.g., tokens) of the data items (e.g., to group the plurality of portions of the data into the plurality of shards that correspond to the plurality of respective timeslots). An embedding is a numerical representation of data (e.g., one or more data items). In an example, the embedding is generated by converting one or more of the data items (e.g., text) into a vector (e.g., an array of numbers). In an aspect, the embedding represents the meaning and the context of the one or more data items. In accordance with this aspect, the distance between a first embedding of first data items(s) and a second embedding of second data item(s) corresponds to a strength of a relationship (e.g., similarity) between the first data item(s) and the second data item(s). For instance, the distance being relatively shorter indicates that the first data item(s) correspond to the second data item(s) to a relatively greater extent, whereas the distance being relatively longer indicates that the first data item(s) correspond to the second data item(s) to a relatively lesser extent.

The distance between a first embedding and a second embedding may be any suitable type of distance, including but not limited to a Euclidian distance (i.e., Pythagorean distance), a Manhattan distance, or a Cosine distance. A Euclidian distance between two vectors is the length of the shortest line between the vectors. In an example, the Euclidian distance, D_{E}, between two 2-dimensional vectors (a, b) and (x, y) is represented as D_{E}=[(a−x)\hat{ }2+(b−y)\hat{ }2]\hat{ }(½). In another example, the Euclidian distance, D_{E}, between two 3-dimensional vectors (a, b, c) and (x, y, z) is represented as D_{E}=[(a−x)\hat{ }2+(b−y)\hat{ }2+(c−z)\hat{ }2]\hat{ }(½). A Manhattan distance between two vectors is a sum of absolute differences between corresponding components of the vectors. In an example, the Manhattan distance, D_{M}, between two 2-dimensional vectors (a, b) and (x, y) is represented as D_{M}=Abs(a−x)+Abs(b−y). In another example, the Manhattan distance, D_{M}, between two 3-dimensional vectors (a, b, c) and (x, y, z) is represented as D_{M}=Abs(a−x)+Abs(b−y)+Abs(c−z). A Cosine distance between two vectors is equal to a dot product of the vectors divided by a product of the magnitudes of the vectors. In an example, the Cosine distance, D_{C}, between vectors X and Y is represented as D_{C}=(X·Y)/(∥X∥*∥Y∥).

An embedding that represents multiple data items may be a combination (e.g., average or median) of respective embeddings of the data items.

In an example embodiment, grouping the plurality of portions of the data into the plurality of shards at step 508 includes computing, by the plurality of first AI accelerators, the maximum size of each of the plurality of sizes of the plurality of shards based at least on a first value, a second value, and a third value. The first value is the maximum bandwidth associated with the plurality of input/output links that connect the Tier0 switch associated with the plurality of first AI accelerators to the Tier1 switch. The second value is the over-subscription ratio. The third value is a latency threshold associated with transmission of a shard using the plurality of input/output links. In an aspect, the maximum size of each of the plurality of sizes of the plurality of shards is based on a hypothetical scenario in which the plurality of shards are included in expert traffic. Expert traffic is data flow that is generated by an AI system that simulates human expert decision-making processes. In another aspect, the latency threshold is specified by a service-level agreement associated with the AI system.

In another example embodiment, the plurality of portions of data that are to be transmitted by the plurality of first AI accelerators to the plurality of second AI accelerators and the plurality of time durations that are to be consumed by transmission of the plurality of portions of the data are defined by an execution graph that is precompiled by the AI system. In accordance with this embodiment, grouping the plurality of portions of the data into the plurality of shards at step 508 includes modifying, by the plurality of first AI accelerators, the execution graph to group the plurality of portions of the data into the plurality of shards corresponding to the plurality of respective timeslots.

At step 510, the plurality of shards are transmitted in the plurality of respective timeslots by designated first AI accelerators in the plurality of first AI accelerators to the plurality of second AI accelerators in the second rack via the Tier1 switch. In an example implementation, designated first AI accelerators in one or more of the subsets 216A-216P transmit the plurality of shards in the plurality of respective timeslots to the plurality of second AI accelerators in the second rack via the Tier1 switch.

In an example embodiment, each of the designated first AI accelerators corresponds to a respective shard of the plurality of shards and a respective timeslot of the plurality of respective timeslots.

In another example embodiment, transmitting the plurality of shards at step 510 includes consuming, by each of the designated first AI accelerators, the maximum bandwidth associated with the plurality of input/output links that connect the Tier0 switch associated with the plurality of first AI accelerators to the Tier1 switch during transmission of the respective shard in the respective timeslot.

In an example implementation, one or more steps 502, 504, 506, 508, and/or 510 of flowchart 500 are not performed. In another example implementation, step(s) in addition to or in lieu of steps 502, 504, 506, 508, and/or 510 are performed.

In an example embodiment, grouping the plurality of portions of the data into the plurality of shards at step 508 includes one or more of the steps shown in flowchart 600 of FIG. 6. As shown in FIG. 6, the method of flowchart 600 begins at step 602. In step 602, an execution graph associated with the task is converted by the plurality of first AI accelerators into a converted execution graph by performing a graph coloring technique on the execution graph. A graph coloring technique is a technique in which clusters of vertices are assigned respective colors. In an aspect, first vertices in a first cluster are assigned a first color; second vertices in a second cluster are assigned a second color, and so on. Performing the graph coloring technique at step 602 clusters a plurality of vertices that represent the plurality of sub-tasks into a plurality of clusters associated with a plurality of colors. Performing the graph coloring technique at step 602 also forms an edge between each pair of vertices in each cluster that correspond to non-overlapping timeslots. In an example, implementation, the first AI accelerators in the subsets 216A-216P convert the execution graph into the converted execution graph.

In an example embodiment, edges in the converted execution graph represent hyperplanes in a lower dimension than the plurality of vertices.

In another example embodiment, performing the graph coloring technique at step 602 includes clustering the plurality of vertices that represent the plurality of sub-tasks into the plurality of clusters associated with the plurality of colors using a k-clustering technique. A k-clustering technique is a technique in which a set of data points is partitioned into k distinct clusters based on attribute(s) associated with the data points. In an example, a first subset of the data points is partitioned into a first cluster based on data points in the first subset sharing one or more first attributes; a second subset of the data points is partitioned into a second cluster based on data points in the second subset sharing one or more second attributes, and so on.

At step 604, a plurality of cluster portions generated by the plurality of first AI accelerators by partitioning each of the plurality of clusters. The plurality of cluster portions correspond to the plurality of shards. In an example implementation, the first AI accelerators in the subsets 216A-216P generate the plurality of cluster portions by partitioning each of the plurality of clusters.

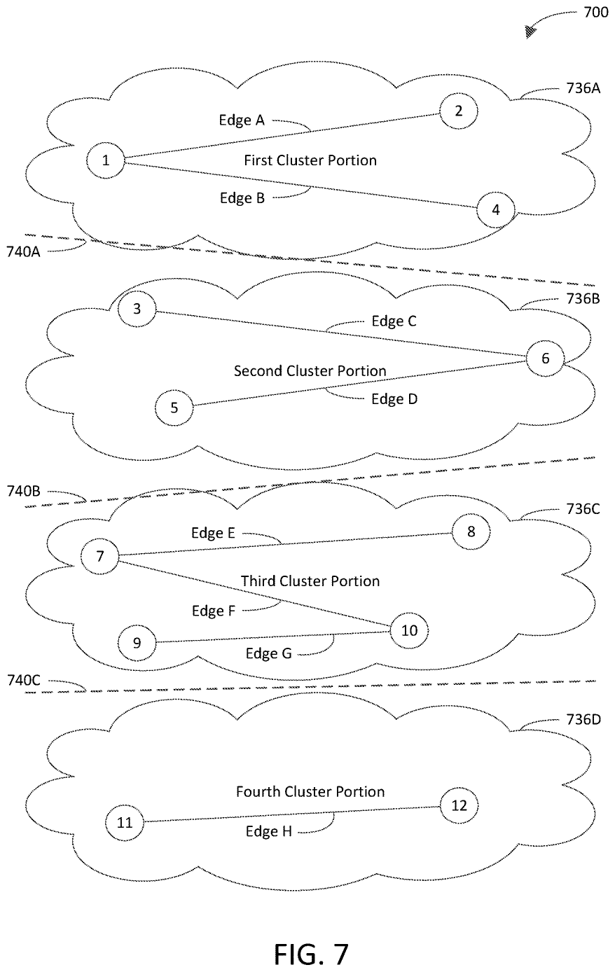

FIG. 7 is a block diagram of an example partitioned execution graph 700 in accordance with an embodiment. In an aspect, the partitioned execution graph 700 is an example result of performing steps of flowchart 600 in FIG. 6. As shown in FIG. 7, the partitioned execution graph 700 is partitioned into a first cluster portion 736A, a second cluster portion 736B, a third cluster portion 736C, and a fourth cluster portion 736D. The first cluster portion 736A and the second cluster portion 736B are separated by a first partition 740A. The second cluster portion and the third cluster portion 736C are separated by a second partition 740B. The third cluster portion 736C and the fourth cluster portion 736D are separated by a third partition 740C.

Vertices 1-12 are clustered among the cluster portions 736A-736D. The vertices 1-12 correspond to respective sub-tasks of a task that is to be performed by an AI system (e.g., over-subscription ratio-based sharding AI system 108). The first cluster portion 736A includes vertex 1, vertex 2, and vertex 4. Vertex 1 is connected to vertex 2 via edge A. Vertex 1 is connected to vertex 4 via edge B. The second cluster portion 736B includes vertex 3, vertex 5, and vertex 6. Vertex 3 is connected to vertex 6 via edge C. Vertex 5 is connected to vertex 6 via edge D. The third cluster portion 736C includes vertices 7-10. Vertex 7 is connected to vertex 8 via edge E. Vertex 7 is connected to vertex 10 via edge F. Vertex 9 is connected to vertex 10 via edge G. The fourth cluster portion 736D includes vertices 11-12. Vertex 11 is connected to vertex 12 via edge H.

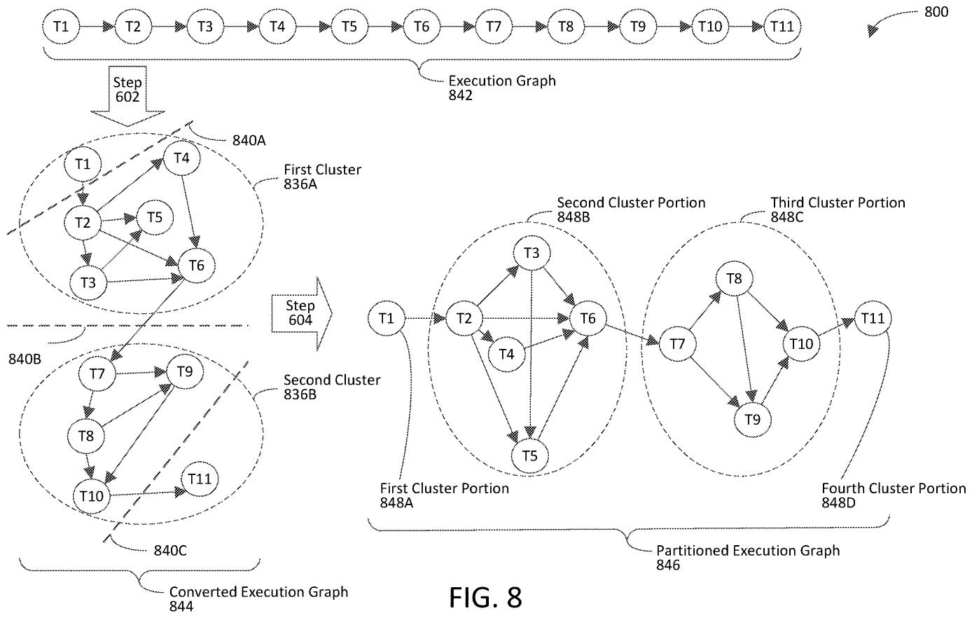

FIG. 8 is a block diagram of states 800 of an execution graph as the execution graph is converted and partitioned in accordance with an embodiment. In a graph coloring aspect, the states 800 represent the various forms of the execution graph as the execution graph is processed in accordance with the steps of flowchart 600 shown in FIG. 6. The states 800 are represented by execution graph 842, converted execution graph 844, and partitioned execution graph 846. In accordance with the graph coloring aspect, the execution graph 842 represents a state of the execution graph prior to performance of step 602 of flowchart 600; the converted execution graph 844 represents a state of the execution graph after performance of step 602 and prior to performance of step 604 of flowchart 600; and the partitioned execution graph 846 represents a state of the execution graph after performance of step 604.

The execution graph 842 is represented linearly to include sub-tasks T1-T11. For clarity, dependencies among the sub-tasks T1-T11 are not shown in the execution graph 842. However, the dependencies are shown in the converted execution graph 844 and the partitioned execution graph 846, which are discussed in further detail below, to demonstrate partitioning. The execution graph 842 is converted into the converted execution graph 844, as described by step 602 of flowchart 600, by performing a graph coloring technique. Performance of the graph coloring technique clusters vertices T1-T12 (which use the same identifiers as the corresponding sub-tasks in the execution graph 846) into clusters, namely a first cluster 836A and a second cluster 836B. Performance of the graph coloring technique further forms an edge between each pair of vertices in each of the clusters 836A-836B that correspond to non-overlapping timeslots. The first cluster 836A corresponds to a first color, and the second cluster 836B corresponds to a second color that is different from the first color.

The first cluster 836A includes vertices T1-T6. T2 is dependent on T2. T3 is dependent on T2. T4 is dependent on T2. T5 is dependent on T2 and T3. T6 is dependent on T2, T3, and T4.

The second cluster 836B includes vertices T7-T11. T7 is dependent on T6. T8 is dependent on T7. T9 is dependent on T7 and T8. T10 is dependent on T8 and T9. T11 is dependent on T10.

The partitioned execution graph 846 is generated from the converted execution graph 844 by partitioning the first cluster 836A and the second cluster 836B to provide cluster portions. As shown in FIG. 8, a first partition 840A partitions the first cluster 836A into a first cluster portion 848A and a second cluster portion 848B. A second partition 840B partitions the first cluster 836A from the second cluster 836B. A third partition 840C partitions the second cluster 836B into a third cluster portion 848C and a fourth cluster portion 848D. The cluster portions 848A-848D correspond to respective shards that are to be transmitted from a first rack associated with a first Tier0 Ethernet switch to a second rack associated with a second Tier0 Ethernet switch via a shared Tier1 Ethernet switch. In an aspect, the shared Tier1 Ethernet switch is shared by the first rack and the second rack. In another aspect, the shared Tier1 Ethernet switch is shared by the first Tier0 Ethernet switch and the second Tier0 Ethernet switch.

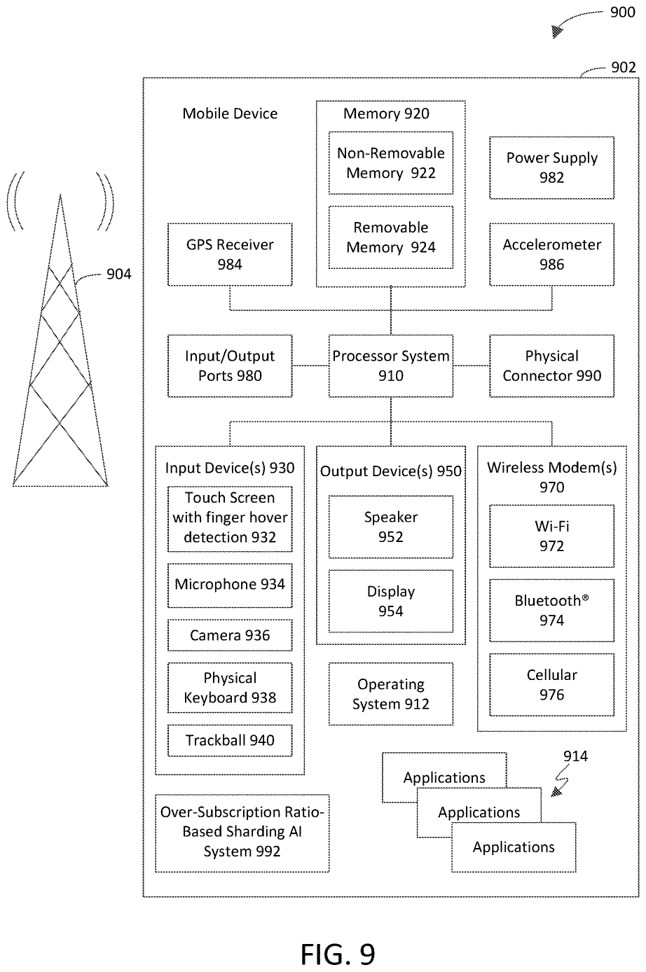

FIG. 9 is a system diagram of an example mobile device 900 including a variety of optional hardware and software components, shown generally as 902. Any components 902 in the mobile device may communicate with any other component, though not all connections are shown, for ease of illustration. In an example, the mobile device 900 is any of a variety of computing devices (e.g., cell phone, smartphone, handheld computer, Personal Digital Assistant (PDA), etc.). In another example, the mobile device 900 allows wireless two-way communications with one or more mobile communications networks 904, such as a cellular or satellite network, or with a local area or wide area network.

The mobile device 900 includes a processor system 910 (e.g., signal processor, microprocessor, ASIC, or other control and processing logic circuitry) for performing such tasks as signal coding, data processing, input/output processing, power control, and/or other functions. In an example, an operating system 912 controls the allocation and usage of the components 902 and support for one or more applications 914 (a.k.a. application programs). In another example, the applications 914 include common mobile computing applications (e.g., email applications, calendars, contact managers, web browsers, messaging applications) and any other computing applications (e.g., word processing applications, mapping applications, media player applications).

The mobile device 900 includes an over-subscription ratio-based sharding AI system 992, which is operable in a manner similar to the over-subscription ratio-based sharding AI system 108 described above with reference to FIG. 1, the over-subscription ratio-based sharding AI system 200 described above with reference to FIG. 2, the over-subscription ratio-based sharding AI system 300 described above with reference to FIG. 3, and/or the over-subscription ratio-based sharding AI system 400 described above with reference to FIG. 4.

The mobile device 900 includes memory 920. In an example, the memory 920 includes non-removable memory 922 and/or removable memory 924. In an aspect, the non-removable memory 922 includes random access memory (RAM), read-only memory (ROM), flash memory, a hard disk, and/or other well-known memory storage technologies. In an example, the removable memory 924 includes flash memory or a Subscriber Identity Module (SIM) card, which is well known in Global System for Mobile Communications (GSM) systems, and/or other well-known memory storage technologies, such as “smart cards.” In an example, the memory 920 stores data and/or code for running the operating system 912 and the applications 914. Examples of data include but are not limited to web pages, text, images, sound files, video data, and other data sets to be sent to and/or received from one or more network servers or other devices via one or more wired or wireless networks. In an example, memory 920 stores a subscriber identifier, such as an International Mobile Subscriber Identity (IMSI), and an equipment identifier, such as an International Mobile Equipment Identifier (IMEI). In another example, such identifiers are transmitted to a network server to identify users and equipment.

In an example, the mobile device 900 supports one or more input devices 930, such as a touch screen 932, microphone 934, camera 936, physical keyboard 938 and/or trackball 940 and one or more output devices 950, such as a speaker 952 and a display 954. In an aspect, touch screens, such as the touch screen 932, detect input in different ways. In an example, capacitive touch screens detect touch input when an object (e.g., a fingertip) distorts or interrupts an electrical current running across the surface. As another example, touch screens use optical sensors to detect touch input when beams from the optical sensors are interrupted. Physical contact with the surface of the screen is not necessary for input to be detected by some touch screens. In an example, the touch screen 932 support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) include but are not limited to piezoelectric or other haptic output devices. In an example, some devices serve more than one input/output function. In another example, touch screen 932 and display 954 are combined in a single input/output device. In yet another example, the input devices 930 include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 912 or applications 914 include speech-recognition software as part of a voice control interface that allows a user to operate the mobile device 900 via voice commands. In another example, the mobile device 900 include input devices and software that allows for user interaction via a user's spatial gestures, such as detecting and interpreting gestures to provide input to a gaming application.

In an example embodiment, wireless modem(s) 970 are coupled to antenna(s) (not shown) and support two-way communications between the processor system 910 and external devices, as is well understood in the art. The modem(s) 970 are shown generically and may include a cellular modem 976 for communicating with the mobile communication network 904 and/or other radio-based modems (e.g., Bluetooth® 974 and/or Wi-Fi 972). At least one of the wireless modem(s) 970 is typically configured for communication with one or more cellular networks, such as a GSM network for data and voice communications within a single cellular network, between cellular networks, or between the mobile device and a public switched telephone network (PSTN).

In some example embodiments, the mobile device 900 further includes at least one input/output port 980, a power supply 982, a satellite navigation system receiver 984, such as a Global Positioning System (GPS) receiver, an accelerometer 986, and/or a physical connector 990. In an example, the physical connector 990 is a universal serial bus (USB) port, IEEE 1394 (FireWire) port, and/or RS-232 port. The illustrated components 902 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. In an example, operations described sequentially are in some cases rearranged or performed concurrently. Moreover, for the sake of simplicity, the attached figures may not show the various ways in which the disclosed methods may be used in conjunction with other methods.

Any one or more of the over-subscription ratio-based sharding AI system 108, the over-subscription ratio-based sharding AI system 200, the over-subscription ratio-based sharding AI system 300, the over-subscription ratio-based sharding AI system 400, any one or more of the processor systems described herein, any one or more of the NICs described herein, any one or more of the AI accelerators described herein, any one or more of the backend network Tier0 Ethernet switches described herein, any one or more of the backend network Tier1 Ethernet switches described herein, flowchart 200, flowchart 300, and/or flowchart 400 may be implemented in hardware, software, firmware, or any combination thereof.

In an example, any one or more of the over-subscription ratio-based sharding AI system 108, the over-subscription ratio-based sharding AI system 200, the over-subscription ratio-based sharding AI system 300, the over-subscription ratio-based sharding AI system 400, any one or more of the processor systems described herein, any one or more of the NICs described herein, any one or more of the AI accelerators described herein, any one or more of the backend network Tier0 Ethernet switches described herein, any one or more of the backend network Tier1 Ethernet switches described herein, flowchart 200, flowchart 300, and/or flowchart 400 is implemented, at least in part, as computer program code configured to be executed in one or more processors.

In another example, any one or more of the over-subscription ratio-based sharding AI system 108, the over-subscription ratio-based sharding AI system 200, the over-subscription ratio-based sharding AI system 300, the over-subscription ratio-based sharding AI system 400, any one or more of the processor systems described herein, any one or more of the NICs described herein, any one or more of the AI accelerators described herein, any one or more of the backend network Tier0 Ethernet switches described herein, any one or more of the backend network Tier1 Ethernet switches described herein, flowchart 200, flowchart 300, and/or flowchart 400 is implemented, at least in part, as hardware logic/electrical circuitry. In an aspect, such hardware logic/electrical circuitry includes one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. In an aspect, a SoC includes an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

(A1) An example artificial intelligence (AI) system (FIG. 1, 108; FIG. 2, 200;

FIG. 3, 300; FIG. 4, 400; FIG. 9, 992) comprises a first rack (FIG. 3, 332; FIG. 4, 432A), a plurality of respective network interface controllers (NICs) (FIG. 2, 218A-218P), and a second rack (FIG. 4, 432B). The first rack comprises a plurality of first AI accelerators. The plurality of respective NICs is associated with the plurality of first AI accelerators. The second rack comprises a plurality of second AI accelerators. The plurality of first AI accelerators is configured to establish (FIG. 5, 502) a consensus regarding allocation of a workload associated with a task among the plurality of first AI accelerators by communicating between a plurality of subsets (FIG. 2, 216A-216P) of the plurality of first AI accelerators via the plurality of respective NICs. The consensus indicates a plurality of portions of data that are to be transmitted by the plurality of first AI accelerators to the plurality of second AI accelerators in the second rack via a Tier1 switch (FIG. 3, 330; FIG. 4, 430) as a result of a plurality of respective sub-tasks performed by the plurality of first AI accelerators. The task includes the plurality of respective sub-tasks. The consensus further indicates a plurality of time durations that are to be consumed by transmission of the plurality of portions of the data. The plurality of first AI accelerators is further configured to group (FIG. 5, 508) the plurality of portions of the data into a plurality of shards corresponding to a plurality of respective timeslots based at least on the plurality of time durations and an over-subscription ratio associated with the plurality of first AI accelerators. Designated first AI accelerators in the plurality of first AI accelerators are configured to transmit (FIG. 5, 510) the plurality of shards in the plurality of respective timeslots to the plurality of second AI accelerators in the second rack via the Tier1 switch.
(A2) In the example AI system of A1, wherein the plurality of first AI accelerators is configured to: group the plurality of portions of the data into the plurality of shards by limiting each of a plurality of sizes of the plurality of shards to be less than or equal to a maximum size that is based at least on a maximum bandwidth associated with a plurality of input/output links that connect a Tier0 switch associated with the plurality of first AI accelerators to the Tier1 switch.
(A3) In the example AI system of any of A1-A2, wherein the plurality of first AI accelerators is configured to group the plurality of portions of the data into the plurality of shards by computing the maximum size of each of the plurality of sizes of the plurality of shards based at least on a first value, a second value, and a third value, wherein the first value is the maximum bandwidth associated with the plurality of input/output links that connect the Tier0 switch associated with the plurality of first AI accelerators to the Tier1 switch, wherein the second value is the over-subscription ratio, and wherein the third value is a latency threshold associated with transmission of a shard using the plurality of input/output links.
(A4) In the example AI system of any of A1-A3, wherein the designated first AI accelerators in the plurality of first AI accelerators are configured to: consume the maximum bandwidth associated with the plurality of input/output links that connect the Tier0 switch associated with the plurality of first AI accelerators to the Tier1 switch during transmission of the shards in the respective timeslots.
(A5) In the example AI system of any of A1-A4, wherein the plurality of sub-tasks include respective pluralities of operations; and wherein each first AI accelerator in the plurality of first AI accelerators receives an indication of a next successive operation in a respective plurality of operations, which is to be performed by the respective first AI accelerator, prior to the respective first AI accelerator completing an operation in the respective plurality of operations that precedes the next successive operation.
(A6) In the example AI system of any of A1-A5, wherein each of the designated first AI accelerators corresponds to a respective shard of the plurality of shards and a respective timeslot of the plurality of respective timeslots.
(A7) In the example AI system of any of A1-A6, wherein the plurality of portions of data that are to be transmitted by the plurality of first AI accelerators to the plurality of second AI accelerators and the plurality of time durations that are to be consumed by transmission of the plurality of portions of the data are defined by an execution graph that is precompiled by the AI system; and wherein the plurality of first AI accelerators is configured to: group the plurality of portions of the data into the plurality of shards corresponding to the plurality of respective timeslots by modifying the execution graph.
(A8) In the example AI system of any of A1-A7, wherein the plurality of first AI accelerators is configured to group the plurality of portions of the data into the plurality of shards by performing the following operations: convert an execution graph associated with the task into a converted execution graph by performing a graph coloring technique on the execution graph, which clusters a plurality of vertices that represent the plurality of sub-tasks into a plurality of clusters associated with a plurality of colors and forms an edge between each pair of vertices in each cluster that correspond to non-overlapping timeslots; and generate a plurality of cluster portions by partitioning each of the plurality of clusters, wherein the plurality of cluster portions correspond to the plurality of shards.
(A9) In the example AI system of any of A1-A8, wherein edges in the converted execution graph represent hyperplanes in a lower dimension than the plurality of vertices.
(A10) In the example AI system of any of A1-A9, wherein the plurality of first AI accelerators is configured to perform the graph coloring technique by clustering the plurality of vertices that represent the plurality of sub-tasks into the plurality of clusters associated with the plurality of colors using a k-clustering technique.
(B1) An example method is implemented by an AI system (FIG. 1, 108; FIG. 2, 200; FIG. 3, 300; FIG. 4, 400; FIG. 9, 992). The method comprises establishing (FIG. 5, 502), by a plurality of first AI accelerators in a first rack (332, 432A) of an AI system (FIG. 1, 108; FIG. 2, 200; FIG. 3, 300; FIG. 4, 400; FIG. 9, 992), a consensus regarding allocation of a workload associated with a task among the plurality of first AI accelerators by communicating between a plurality of subsets (FIG. 2, 216A-216P) of the plurality of first AI accelerators via a plurality of network interface controllers (FIG. 2, 218A-218P) associated with the plurality of subsets. The consensus indicates a plurality of portions of data that are to be transmitted by the plurality of first AI accelerators to a plurality of second AI accelerators in a second rack (FIG. 4, 432B) of the AI system via a Tier1 switch (FIG. 3, 330; FIG. 4, 430) as a result of a plurality of sub-tasks performed by the plurality of first AI accelerators. The task includes the plurality of sub-tasks. The consensus further indicates a plurality of time durations that are to be consumed by transmission of the plurality of portions of the data. The method further comprises receiving (FIG. 5, 504) an AI input, which requests performance of the task, at the AI system. The method further comprises generating (FIG. 5, 506), by the AI system, an AI response that is responsive to the AI input. Generating the AI response comprises grouping (FIG. 5, 508), by the plurality of first AI accelerators, the plurality of portions of the data into a plurality of shards corresponding to a plurality of respective timeslots based at least on the plurality of time durations and an over-subscription ratio associated with the plurality of first AI accelerators by limiting each of a plurality of sizes of the plurality of shards to be less than or equal to a maximum size that is based at least on a maximum bandwidth associated with a plurality of input/output links (FIG. 2, 226; FIG. 3, 326; FIG. 4, 426A) that connect a Tier0 switch (FIG. 2, 220; FIG. 3, 320; FIG. 4, 420A) associated with the plurality of first AI accelerators to the Tier1 switch. Generating the AI response further comprises transmitting (FIG. 5, 510), by designated first AI accelerators in the plurality of first AI accelerators, the plurality of shards in the plurality of respective timeslots to the plurality of second AI accelerators in the second rack via the Tier1 switch.
(B2) In the example method of B1, wherein the plurality of sub-tasks include respective pluralities of operations; and wherein each first AI accelerator in the plurality of first AI accelerators receives an indication of a next successive operation in a respective plurality of operations, which is to be performed by the respective first AI accelerator, prior to the respective first AI accelerator completing an operation in the respective plurality of operations that precedes the next successive operation.
(B3) In the example method of any of B1-B2, wherein transmitting the plurality of shards comprises: transmitting, by the designated first AI accelerators, respective shards of the plurality of shards in respective timeslots of the plurality of respective timeslots.
(B4) In the example method of any of B1-B3, wherein transmitting the plurality of shards comprises: consuming, by each of the designated first AI accelerators, the maximum bandwidth associated with the plurality of input/output links that connect the Tier0 switch associated with the plurality of first AI accelerators to the Tier1 switch during transmission of the respective shard in the respective timeslot.
(B5) In the example method of any of B1-B4, wherein grouping the plurality of portions of the data into the plurality of shards comprises: computing, by the plurality of first AI accelerators, the maximum size of each of the plurality of sizes of the plurality of shards based at least on a first value, a second value, and a third value, wherein the first value is the maximum bandwidth associated with the plurality of input/output links that connect the Tier0 switch associated with the plurality of first AI accelerators to the Tier1 switch, wherein the second value is the over-subscription ratio, and wherein the third value is a latency threshold associated with transmission of a shard using the plurality of input/output links.
(B6) In the example method of any of B1-B5, wherein the plurality of portions of data that are to be transmitted by the plurality of first AI accelerators to the plurality of second AI accelerators and the plurality of time durations that are to be consumed by transmission of the plurality of portions of the data are defined by an execution graph that is precompiled by the AI system; and wherein grouping the plurality of portions of the data into the plurality of shards comprises: modifying, by the plurality of first AI accelerators, the execution graph to group the plurality of portions of the data into the plurality of shards corresponding to the plurality of respective timeslots.
(B7) In the example method of any of B1-B6, wherein grouping the plurality of portions of the data into the plurality of shards comprises: converting, by the plurality of first AI accelerators, an execution graph associated with the task into a converted execution graph by performing a graph coloring technique on the execution graph, which clusters a plurality of vertices that represent the plurality of sub-tasks into a plurality of clusters associated with a plurality of colors and forms an edge between each pair of vertices in each cluster that correspond to non-overlapping timeslots; and generating, by the plurality of first AI accelerators, a plurality of cluster portions by partitioning each of the plurality of clusters, wherein the plurality of cluster portions correspond to the plurality of shards.
(B8) In the example method of any of B1-B7, wherein performing the graph coloring technique comprises: clustering the plurality of vertices that represent the plurality of sub-tasks into the plurality of clusters associated with the plurality of colors using a k-clustering technique.
(C1) An example system (FIG. 1, 100) comprises a memory (FIG. 9, 920) and an AI system (FIG. 1, 108; FIG. 2, 200; FIG. 3, 300; FIG. 4, 400; FIG. 9, 992). The memory stores an artificial intelligence (AI) model. The AI system is configured to execute the AI model. The AI system comprises a first rack (332, 432A), a plurality of respective network interface controllers (NICs) (218A-218P), and a second rack (432B). The first rack comprises a plurality of first AI accelerators. The plurality of respective NICs are associated with the plurality of first AI accelerators. The second rack comprises a plurality of second AI accelerators. The plurality of first AI accelerators is configured to establish (FIG. 5, 502) a consensus regarding allocation of a workload associated with a task among the plurality of first AI accelerators by communicating between a plurality of subsets (FIG. 2, 216A-216P) of the plurality of first AI accelerators via the plurality of respective NICs. The consensus indicates a plurality of portions of data that are to be transmitted by the plurality of first AI accelerators to the plurality of second AI accelerators in the second rack via a Tier1 switch (FIG. 3, 330; FIG. 4, 430) as a result of a plurality of respective sub-tasks performed by the plurality of first AI accelerators. The task includes the plurality of respective sub-tasks. The consensus further indicates a plurality of time durations that are to be consumed by transmission of the plurality of portions of the data. The plurality of first AI accelerators is further configured to group (FIG. 5, 508) the plurality of portions of the data into a plurality of shards corresponding to a plurality of respective timeslots by computing a maximum size of each of a plurality of sizes of the plurality of shards based at least on a plurality of first values, a second value, a third value, and a fourth value. The plurality of first values is the plurality of time durations. The second value is a maximum bandwidth associated with a plurality of input/output links (FIG. 2, 226; FIG. 3, 326; FIG. 4, 426A) that connect a Tier0 switch (FIG. 2, 220; FIG. 3, 320; FIG. 4, 420A) associated with the plurality of first AI accelerators to the Tier1 switch. The third value is an over-subscription ratio associated with the plurality of first AI accelerators. The fourth value is a latency threshold associated with transmission of a shard using the plurality of input/output links. Designated first AI accelerators in the plurality of first AI accelerators are configured to transmit (FIG. 5, 510) the plurality of shards in the plurality of respective timeslots to the plurality of second AI accelerators in the second rack via the Tier1 switch.
(C2) In the example system of C1, wherein an identified sub-task performed by an identified first AI accelerator includes a plurality of operations; wherein the identified first AI accelerator receives an indication of a next successive operation in a plurality of operations, which is to be performed by the identified first AI accelerator, prior to the identified first AI accelerator completing an operation in the plurality of operations that precedes the next successive operation; wherein the plurality of first AI accelerators includes the identified first AI accelerator; and wherein the plurality of respective sub-tasks includes the identified sub-task.

### III. Example Computer System

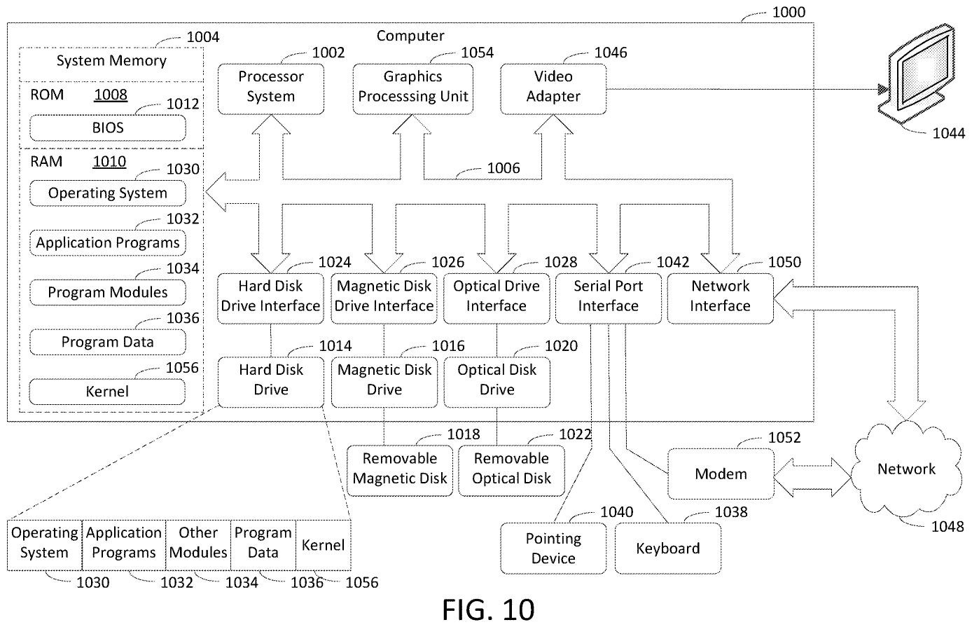

FIG. 10 depicts an example computer 1000 in which embodiments may be implemented. Any one or more of the client devices 102A-102M and/or any one or more of the servers 106A-106N shown in FIG. 1 may be implemented using computer 1000, including one or more features of computer 1000 and/or alternative features. In an example, computer 1000 is a general-purpose computing device in the form of a conventional personal computer, a mobile computer, or a workstation. In another example, computer 1000 is a special purpose computing device. The description of computer 1000 provided herein is provided for purposes of illustration, and is not intended to be limiting. Embodiments are capable of being implemented in further types of computer systems, as would be known to persons skilled in the relevant art(s).

As shown in FIG. 10, computer 1000 includes a processor system 1002, a system memory 1004, and a bus 1006 that couples various system components including system memory 1004 to processor system 1002. Bus 1006 represents one or more of any of several types of bus structures, including a memory bus or memory controller, a peripheral bus, an accelerated graphics port, and a processor or local bus using any of a variety of bus architectures. System memory 1004 includes read only memory (ROM) 1008 and random access memory (RAM) 1010. A basic input/output system 1012 (BIOS) is stored in ROM 1008.

Computer 1000 also has one or more of the following drives: a hard disk drive 1014 for reading from and writing to a hard disk, a magnetic disk drive 1016 for reading from or writing to a removable magnetic disk 1018, and an optical disk drive 1020 for reading from or writing to a removable optical disk 1022 such as a CD ROM, DVD ROM, or other optical media. Hard disk drive 1014, magnetic disk drive 1016, and optical disk drive 1020 are connected to bus 1006 by a hard disk drive interface 1024, a magnetic disk drive interface 1026, and an optical drive interface 1028, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

In an example, a number of program modules are stored on the hard disk, magnetic disk, optical disk, ROM, or RAM. These programs include an operating system 1030, one or more application programs 1032, other program modules 1034, and program data 1036. In an aspect, application programs 1032 or program modules 1034 include computer program logic for implementing any one or more of (e.g., at least a portion of) the over-subscription ratio-based sharding AI system 108, the over-subscription ratio-based sharding AI system 200, the over-subscription ratio-based sharding AI system 300, the over-subscription ratio-based sharding AI system 400, any one or more of the processor systems described herein, any one or more of the NICs described herein, any one or more of the AI accelerators described herein, any one or more of the backend network Tier0 Ethernet switches described herein, any one or more of the backend network Tier1 Ethernet switches described herein, flowchart 200 (including any step of flowchart 200), flowchart 300 (including any step of flowchart 300), and/or flowchart 400 (including any step of flowchart 400), as described herein.

In an example, a user enters commands and information into the computer 1000 through input devices such as keyboard 1038 and pointing device 1040. Other input devices (not shown) include but are not limited to a microphone, a joystick, a game pad, a satellite dish, a scanner, a touch screen, a camera, an accelerometer, and a gyroscope. These and other input devices are often connected to the processor system 1002 through a serial port interface 1042 that is coupled to bus 1006, but may be connected by other interfaces, such as a parallel port, game port, or a universal serial bus (USB).

A display device 1044 (e.g., a monitor) is also connected to bus 1006 via an interface, such as a video adapter 1046. In an example, computer 1000 includes other peripheral output devices (not shown), such as a speaker and/or a printer, in addition to display device 1044.

Computer 1000 is connected to a network 1048 (e.g., the Internet) through a network interface 1050 (e.g., a network or adapter), a modem 1052, or other means for establishing communications over the network. Modem 1052 is connected to bus 1006 via serial port interface 1042. In an example, modem 1052 is inside computer 1000. In another example, modem 1052 is external to computer 1000.

As used herein, the terms “computer program medium” and “computer-readable storage medium” are used to generally refer to media (e.g., non-transitory media) such as the hard disk associated with hard disk drive 1014, removable magnetic disk 1018, removable optical disk 1022, as well as other media such as flash memory cards, digital video disks, random access memories (RAMs), read only memories (ROM), and the like. A computer-readable storage medium is not a signal, such as a carrier signal or a propagating signal. In an example, a computer-readable storage medium does not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

In an example, computer programs and modules (including application programs 1032 and other program modules 1034) are stored on the hard disk, magnetic disk, optical disk, ROM, or RAM. In another example, such computer programs are also received via network interface 1050 or serial port interface 1042. Such computer programs, when executed or loaded by an application, enable computer 1000 to implement features of embodiments discussed herein. Accordingly, such computer programs represent controllers of the computer 1000.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment need not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. An artificial intelligence (AI) system comprising:
a first rack that comprises a plurality of first AI accelerators;
a plurality of respective network interface controllers (NICs) associated with the plurality of first AI accelerators; and
a second rack that comprises a plurality of second AI accelerators;
wherein the plurality of first AI accelerators is configured to:
establish a consensus regarding allocation of a workload associated with a task among the plurality of first AI accelerators by communicating between a plurality of subsets of the plurality of first AI accelerators via the plurality of respective NICs, wherein the consensus indicates a plurality of portions of data that are to be transmitted by the plurality of first AI accelerators to the plurality of second AI accelerators in the second rack via a Tier1 switch as a result of a plurality of respective sub-tasks performed by the plurality of first AI accelerators, wherein the task includes the plurality of respective sub-tasks, and wherein the consensus further indicates a plurality of time durations that are to be consumed by transmission of the plurality of portions of the data; and
group the plurality of portions of the data into a plurality of shards corresponding to a plurality of respective timeslots based at least on the plurality of time durations and an over-subscription ratio associated with the plurality of first AI accelerators; and
wherein designated first AI accelerators in the plurality of first AI accelerators are configured to:
transmit the plurality of shards in the plurality of respective timeslots to the plurality of second AI accelerators in the second rack via the Tier1 switch.

2. The AI system of claim 1, wherein the plurality of first AI accelerators is configured to:
group the plurality of portions of the data into the plurality of shards by limiting each of a plurality of sizes of the plurality of shards to be less than or equal to a maximum size that is based at least on a maximum bandwidth associated with a plurality of input/output links that connect a Tier0 switch associated with the plurality of first AI accelerators to the Tier1 switch.

3. The AI system of claim 2, wherein the plurality of first AI accelerators is configured to group the plurality of portions of the data into the plurality of shards by computing the maximum size of each of the plurality of sizes of the plurality of shards based at least on a first value, a second value, and a third value,
wherein the first value is the maximum bandwidth associated with the plurality of input/output links that connect the Tier0 switch associated with the plurality of first AI accelerators to the Tier1 switch,
wherein the second value is the over-subscription ratio, and
wherein the third value is a latency threshold associated with transmission of a shard using the plurality of input/output links.

4. The AI system of claim 3, wherein the designated first AI accelerators in the plurality of first AI accelerators are configured to:
consume the maximum bandwidth associated with the plurality of input/output links that connect the Tier0 switch associated with the plurality of first AI accelerators to the Tier1 switch during transmission of the plurality of shards in the plurality of respective timeslots.

5. The AI system of claim 1, wherein the plurality of sub-tasks include respective pluralities of operations; and
wherein each first AI accelerator in the plurality of first AI accelerators receives an indication of a next successive operation in a respective plurality of operations, which is to be performed by the respective first AI accelerator, prior to the respective first AI accelerator completing an operation in the respective plurality of operations that precedes the next successive operation.

6. The AI system of claim 1, wherein each of the designated first AI accelerators corresponds to a respective shard of the plurality of shards and a respective timeslot of the plurality of respective timeslots.

7. The AI system of claim 1, wherein the plurality of portions of data that are to be transmitted by the plurality of first AI accelerators to the plurality of second AI accelerators and the plurality of time durations that are to be consumed by transmission of the plurality of portions of the data are defined by an execution graph that is precompiled by the AI system; and
wherein the plurality of first AI accelerators is configured to:
group the plurality of portions of the data into the plurality of shards corresponding to the plurality of respective timeslots by modifying the execution graph.

8. The AI system of claim 1, wherein the plurality of first AI accelerators is configured to group the plurality of portions of the data into the plurality of shards by performing the following operations:
convert an execution graph associated with the task into a converted execution graph by performing a graph coloring technique on the execution graph, which clusters a plurality of vertices that represent the plurality of sub-tasks into a plurality of clusters associated with a plurality of colors and forms an edge between each pair of vertices in each cluster that correspond to non-overlapping timeslots; and
generate a plurality of cluster portions by partitioning each of the plurality of clusters, wherein the plurality of cluster portions correspond to the plurality of shards.

9. The AI system of claim 8, wherein edges in the converted execution graph represent hyperplanes in a lower dimension than the plurality of vertices.

10. The AI system of claim 8, wherein the plurality of first AI accelerators is configured to perform the graph coloring technique by clustering the plurality of vertices that represent the plurality of sub-tasks into the plurality of clusters associated with the plurality of colors using a k-clustering technique.

11. A method implemented by an AI system in a computing system, the method comprising:
establishing, by a plurality of first AI accelerators in a first rack of an AI system, a consensus regarding allocation of a workload associated with a task among the plurality of first AI accelerators by communicating between a plurality of subsets of the plurality of first AI accelerators via a plurality of network interface controllers associated with the plurality of subsets, wherein the consensus indicates a plurality of portions of data that are to be transmitted by the plurality of first AI accelerators to a plurality of second AI accelerators in a second rack of the AI system via a Tier1 switch as a result of a plurality of sub-tasks performed by the plurality of first AI accelerators, wherein the task includes the plurality of sub-tasks, and wherein the consensus further indicates a plurality of time durations that are to be consumed by transmission of the plurality of portions of the data;
receiving an AI input, which requests performance of the task, at the AI system; and
generating, by the AI system, an AI response that is responsive to the AI input, wherein generating the AI response comprises:
grouping, by the plurality of first AI accelerators, the plurality of portions of the data into a plurality of shards corresponding to a plurality of respective timeslots based at least on the plurality of time durations and an over-subscription ratio associated with the plurality of first AI accelerators by limiting each of a plurality of sizes of the plurality of shards to be less than or equal to a maximum size that is based at least on a maximum bandwidth associated with a plurality of input/output links that connect a Tier0 switch associated with the plurality of first AI accelerators to the Tier1 switch; and
transmitting, by designated first AI accelerators in the plurality of first AI accelerators, the plurality of shards in the plurality of respective timeslots to the plurality of second AI accelerators in the second rack via the Tier1 switch.

12. The method of claim 11, wherein the plurality of sub-tasks include respective pluralities of operations; and
wherein each first AI accelerator in the plurality of first AI accelerators receives an indication of a next successive operation in a respective plurality of operations, which is to be performed by the respective first AI accelerator, prior to the respective first AI accelerator completing an operation in the respective plurality of operations that precedes the next successive operation.

13. The method of claim 11, wherein transmitting the plurality of shards comprises:
transmitting, by the designated first AI accelerators, respective shards of the plurality of shards in respective timeslots of the plurality of respective timeslots.

14. The method of claim 13, wherein transmitting the plurality of shards comprises:
consuming, by each of the designated first AI accelerators, the maximum bandwidth associated with the plurality of input/output links that connect the Tier0 switch associated with the plurality of first AI accelerators to the Tier1 switch during transmission of the respective shard in the respective timeslot.

15. The method of claim 11, wherein grouping the plurality of portions of the data into the plurality of shards comprises:
computing, by the plurality of first AI accelerators, the maximum size of each of the plurality of sizes of the plurality of shards based at least on a first value, a second value, and a third value,
wherein the first value is the maximum bandwidth associated with the plurality of input/output links that connect the Tier0 switch associated with the plurality of first AI accelerators to the Tier1 switch,
wherein the second value is the over-subscription ratio, and
wherein the third value is a latency threshold associated with transmission of a shard using the plurality of input/output links.

16. The method of claim 11, wherein the plurality of portions of data that are to be transmitted by the plurality of first AI accelerators to the plurality of second AI accelerators and the plurality of time durations that are to be consumed by transmission of the plurality of portions of the data are defined by an execution graph that is precompiled by the AI system; and
wherein grouping the plurality of portions of the data into the plurality of shards comprises:
modifying, by the plurality of first AI accelerators, the execution graph to group the plurality of portions of the data into the plurality of shards corresponding to the plurality of respective timeslots.

17. The method of claim 11, wherein grouping the plurality of portions of the data into the plurality of shards comprises:
converting, by the plurality of first AI accelerators, an execution graph associated with the task into a converted execution graph by performing a graph coloring technique on the execution graph, which clusters a plurality of vertices that represent the plurality of sub-tasks into a plurality of clusters associated with a plurality of colors and forms an edge between each pair of vertices in each cluster that correspond to non-overlapping timeslots; and
generating, by the plurality of first AI accelerators, a plurality of cluster portions by partitioning each of the plurality of clusters, wherein the plurality of cluster portions correspond to the plurality of shards.

18. The method of claim 17, wherein performing the graph coloring technique comprises:
clustering the plurality of vertices that represent the plurality of sub-tasks into the plurality of clusters associated with the plurality of colors using a k-clustering technique.

19. A system comprising:
a memory that stores an artificial intelligence (AI) model; and
an AI system configured to execute the AI model, the AI system comprising:
a first rack that comprises a plurality of first AI accelerators;
a plurality of respective network interface controllers (NICs) associated with the plurality of first AI accelerators; and
a second rack that comprises a plurality of second AI accelerators;
wherein the plurality of first AI accelerators is configured to:
establish a consensus regarding allocation of a workload associated with a task among the plurality of first AI accelerators by communicating between a plurality of subsets of the plurality of first AI accelerators via the plurality of respective NICs, wherein the consensus indicates a plurality of portions of data that are to be transmitted by the plurality of first AI accelerators to the plurality of second AI accelerators in the second rack via a Tier1 switch as a result of a plurality of respective sub-tasks performed by the plurality of first AI accelerators, wherein the task includes the plurality of respective sub-tasks, and wherein the consensus further indicates a plurality of time durations that are to be consumed by transmission of the plurality of portions of the data; and
group the plurality of portions of the data into a plurality of shards corresponding to a plurality of respective timeslots by computing a maximum size of each of a plurality of sizes of the plurality of shards based at least on a plurality of first values, a second value, a third value, and a fourth value,
wherein the plurality of first values is the plurality of time durations,
wherein the second value is a maximum bandwidth associated with a plurality of input/output links that connect a Tier0 switch associated with the plurality of first AI accelerators to the Tier1 switch,
wherein the third value is an over-subscription ratio associated with the plurality of first AI accelerators, and
wherein the fourth value is a latency threshold associated with transmission of a shard using the plurality of input/output links; and
wherein designated first AI accelerators in the plurality of first AI accelerators are configured to:
transmit the plurality of shards in the plurality of respective timeslots to the plurality of second AI accelerators in the second rack via the Tier1 switch.

20. The system of claim 19, wherein an identified sub-task performed by an identified first AI accelerator includes a plurality of operations;
wherein the identified first AI accelerator receives an indication of a next successive operation in a plurality of operations, which is to be performed by the identified first AI accelerator, prior to the identified first AI accelerator completing an operation in the plurality of operations that precedes the next successive operation;
wherein the plurality of first AI accelerators includes the identified first AI accelerator; and
wherein the plurality of respective sub-tasks includes the identified sub-task.
